(19) United States
(12) Patent Application Publication
(10) Pub. No.: US 2025/0016813 A1
(43) Pub. Date: Jan. 9, 2025

(54) COMMUNICATION METHOD, COMMUNICATION DEVICE, AND CHIP

(71) Applicant: GUANGDONG OPPO MOBILE TELECOMMUNICATIONS CORP., LTD., Dongguan (CN)

(72) Inventors: Pei ZHOU, Dongguan (CN); Lei HUANG, Singapore (SG); Chaoming LUO, Dongguan (CN); Ning GAO, Dongguan (CN)

(21) Appl. No.: 18/890,100

(22) Filed: Sep. 19, 2024

Related U.S. Application Data
(63) Continuation of application No. PCT/CN2022/087774, filed on Apr. 19, 2022.

(51) Int. Cl. H04W 72/541; H04W 72/1263; H04W 84/12

(52) U.S. Cl. CPC H04W 72/541; H04W 72/1263; H04W 84/12

(57) ABSTRACT

The communication method includes: assigning, by a first device, a beam/sector/channel that causes no interference to other devices to a second device, and scheduling the second device to transmit sensing information on the beam/sector/channel, wherein transmission of the sensing information causes no interference to the other devices.

### CROSS-REFERENCE TO RELATED APPLICATION

This application is a continuation application of International Application No. PCT/CN2022/087774, filed on Apr. 19, 2022, the entire disclosure of which is hereby incorporated herein by reference.

### TECHNICAL FIELD

The present disclosure relates to the technical field of communications, and in particular, relates to a communication method, a communication device, and a chip.

### BACKGROUND

During wireless local area network (WLAN) sensing, sensing information transmitted by each of the devices is likely to cause interference to each other's reception.

### SUMMARY

Embodiments of the present disclosure provide a communication method, a device, and a chip.

Some embodiments of the present disclosure provide a communication method. The method is applicable to a first device, and includes: scheduling a second device to transmit sensing information, wherein transmission of the sensing information causes no interference to other devices.

Some embodiments of the present disclosure provide a communication method. The method is applicable to a second device, and includes: transmitting sensing information in response to scheduling by a first device, wherein transmission of the sensing information causes no interference to other devices.

Some embodiments of the present disclosure provide a communication device. The communication device includes: a processor and a memory, wherein the memory stores one or more computer programs, and the processor, when loading and running the one or more computer programs in the memory, causes the communication device to perform the method described in any embodiment of the present disclosure.

Some embodiments of the present disclosure provide a chip, configured to implement the above method. The chip includes a processor, wherein the processor, when loading and running one or more computer programs from a memory, causes a device equipped with the chip to perform the method described in any embodiment of the present disclosure.

### BRIEF DESCRIPTION OF THE DRAWINGS

FIG. 1 is a schematic diagram of an application scenario according to some embodiments of the present disclosure.

FIG. 2 is a schematic flowchart of a communication method 200 according to some embodiments of the present disclosure.

FIG. 3 is a schematic diagram of an implementation method for acquiring a position and beam/sector information of a responder according to some embodiments of the present disclosure.

FIG. 4 is a schematic structural diagram of a sensing beam element according to some embodiments of the present disclosure.

FIG. 5A is a schematic structural diagram of a sensing beam description element according to some embodiments of the present disclosure.

FIG. 5B is a schematic structural diagram of another sensing beam description element according to some embodiments of the present disclosure.

FIG. 5C is a schematic structural diagram of another sensing beam description element according to some embodiments of the present disclosure.

FIG. 6 is a schematic structural diagram of a sensing sector element according to some embodiments of the present disclosure.

FIG. 7A is a schematic structural diagram of a sensing sector description element according to some embodiments of the present disclosure.

FIG. 7B is a schematic structural diagram of another sensing sector description element according to some embodiments of the present disclosure.

FIG. 7C is a schematic structural diagram of another sensing sector description element according to some embodiments of the present disclosure.

FIG. 8 is a topology diagram of a DMG coordinated sensing network according to some embodiments of the present disclosure.

FIG. 9 is a flowchart of an implementation of scheduling STAs causing no interference to each other and transmitting sensing PPDUs simultaneously in a DMG coordinated monostatic sensing scenario according to some embodiments of the present disclosure.

FIG. 10 is a flowchart of an implementation of scheduling STAs causing no interference to each other and transmitting sensing PPDUs simultaneously in a DMG coordinated bistatic sensing scenario according to some embodiments of the present disclosure.

FIG. 11A is a flowchart of a DMG coordinated monostatic sensing according to some embodiments of the present disclosure.

FIG. 11B is a flowchart of a DMG coordinated bistatic sensing according to some embodiments of the present disclosure.

FIG. 12A is a schematic diagram of a format of a DMG measurement setup request frame according to some embodiments of the present disclosure.

FIG. 12B is a schematic diagram of a format of a coordinated monostatic/bistatic instance request frame according to some embodiments of the present disclosure.

FIG. 12C is a schematic diagram of an initiator scheduling different STAs to transmit monostatic sensing PPDUs on different channels according to some embodiments of the present disclosure.

FIG. 12D is a schematic diagram of an initiator scheduling STA B to transmit bistatic sensing PPDUs on a different channel according to some embodiments of the present disclosure.

FIG. 12E is a schematic diagram of a format of a DMG measurement setup request frame according to some embodiments of the present disclosure.

FIG. 12F is a schematic diagram of a format of a coordinated monostatic/bistatic instance request frame according to some embodiments of the present disclosure.

FIG. 13 is a schematic flowchart of a communication method 1300 according to embodiments of the present disclosure.

FIG. 14 is a schematic structural diagram of a communication device 1400 according to embodiments of the present disclosure.

FIG. 15 is a schematic structural diagram of a communication device 1500 according to some embodiments of the present disclosure.

FIG. 16 is a schematic structural diagram of a communication device 1600 according to some embodiments of the present disclosure.

FIG. 17 is a schematic structural diagram of a communication device 1700 according to some embodiments of the present disclosure.

FIG. 18 is a schematic structural diagram of a communication device 1800 according to some embodiments of the present disclosure.

FIG. 19 is a schematic structural diagram of a chip 1900 according to some embodiments of the present disclosure.

### DETAILED DESCRIPTION

The technical solutions according to the embodiments of the present disclosure are described hereinafter in conjunction with the accompanying drawings for the embodiments of the present disclosure. It should be noted that the terms “first” and “second” in the description and the claims of

the embodiments of the present disclosure and the above accompanying drawings are used to distinguish similar objects, and are not used to describe a particular order or sequence. The objects described by the “first” and “second” can be the same or different.

The technical solutions according to the embodiments of the present disclosure can be applied to various communication systems, such as a WLAN, a wireless fidelity (Wi-Fi) system, or other communication systems.

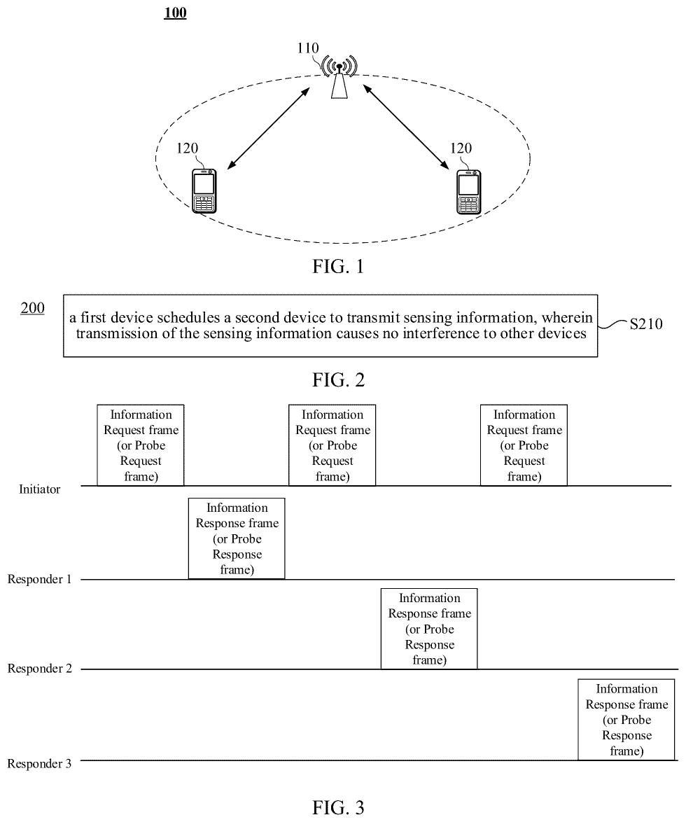

In some embodiments, the communication system 100 applied by embodiments of the present disclosure is shown in FIG. 1. The communication system 100 includes an access point (AP) 110 and stations (STAs) 120, wherein the STA 120 accesses a network over the AP 110.

In some scenarios, the AP is also referred to as an AP STA, i.e., in a sense, the AP is also an STA.

In some scenarios, the STA or is referred to a non-AP STA.

Communication within the communication system 100 involves communication between an AP and a non-AP STA, communication between a non-AP STA and a non-AP STA, or communication between an STA and a peer STA. The peer STA refers to a device communicating with the STA at an opposite terminal, e.g., the peer STA is an AP or a non-AP STA.

The AP functions as a bridge connecting a wired network and a wireless network, primarily serving to connect various wireless network clients together and then access the wireless network to the Ethernet. An AP device may a terminal device equipped with a Wi-Fi chip (e.g., a mobile phone) or a network device equipped with a Wi-Fi chip (e.g., a router).

It is understandable that a role of an STA in a communication system is not absolute. For example, in some scenarios, when a mobile phone connects to a router, the mobile phone acts as a non-AP STA. When the mobile phone serves as a hotspot for another mobile phone, the mobile phone acts as an AP.

Both the AP and non-AP STA may be devices applied in the Internet of vehicles, nodes and sensors in the Internet of things (IOT), smart cameras, smart remotes, smart water meters, and smart electricity meters in smart homes, or sensors in smart cities.

In some embodiments, the non-AP STA supports 802.11be. The non-AP STA may also support 802.11ax, 802.11ac, 802.11n, 802.11g, 802.11b, 802.11a, and various current and future WLAN technologies of the 802.11 series.

In some embodiments, the AP is a device that supports 802.11be. The AP may also a device that supports 802.11ax, 802.11ac, 802.11n, 802.11g, 802.11b, 802.11a, and various current and future WLAN technologies of the 802.11 series.

In some embodiments of the present disclosure, the STA is a device that supports WLAN or Wi-Fi technology such as a mobile phone, a tablet computer (Pad), a computer, a virtual reality (VR) device, an augmented reality (AR) device, a wireless device in industrial control, a set-top box, a wireless device in self-driving, an in-vehicle communication device, a wireless device in remote medical, a wireless device in smart grid, a wireless device in transportation safety, a wireless device in smart city, or a wireless device or a wireless communication chip/ASIC/SOC in smart home.

Frequency bands supported by WLAN technology include, but are not limited to: low-frequency bands (e.g., 2.4 GHZ, 5 GHZ, 6 GHZ), and high frequency bands (e.g., 60 GHZ).

FIG. 1 illustrates one AP station and two non-AP STAs. In some embodiments, the communication system 100 includes a plurality of AP STAs and other numbers of non-AP STAs, which are not limited in the embodiments of the present disclosure.

It is understandable that the terms “system” and “network” are often used interchangeably herein. The term “and/or” herein is merely a description of an association relationship between associated objects, indicating that there are three possible relationships. For example, the phrase “A and/or B” means (A), (B), or (A and B). In addition, the symbol “/” herein generally indicates an “or” relationship between the associated objects.

It is understandable that the term “indication” mentioned in the embodiments of the present disclosure is a direct indication, an indirect indication, or an indication that there is an associated relationship. For example, A indicates B, which may mean that A indicates B directly, e.g., Bis acquired by A; or that A indicates B indirectly, e.g., A indicates C, wherein B is acquired by C; or that an association relationship is present between A and B.

In the description of the embodiments of the present disclosure, the term “corresponding” may indicate a direct corresponding relationship or an indirect corresponding relationship between two items, or indicate an associated relationship between two items, or indicate relationships such as indicating and being indicated, configuring and being configured, or the like.

To facilitate understanding of the technical solutions according to the embodiments of the present disclosure, the following describes the relevant technologies of the embodiments of the present disclosure, and the following relevant technologies can be combined with the technical solutions of the embodiments of the present disclosure as optional solutions, and all of them fall within protection scope of the embodiments of the present disclosure.

In a directional multi-gigabit (DMG) coordinated monostatic sensing mode, a sensing initiator schedules a plurality of sensing responders to transmit sensing information, e.g., physical layer protocol data unit (PPDU), simultaneously. The sensing PPDUs (e.g., monostatic sensing PPDU, which is also be referred to as monostatic PPDU) transmitted by a responder may cause interference to the reception of other responders, thereby affecting the DMG monostatic sensing results. Similarly, scheduling a plurality of responders to transmit sensing PPDUs simultaneously (e.g., bistatic sensing PPDU, which is also be referred to as bistatic PPDU) is supported in the

DMG coordinated bistatic sensing mode. This mode also has the problem that bistatic PPDUs transmitted by a responder may cause interference to the reception of the other responders, thereby affecting the DMG bistatic sensing results.

Some embodiments of the present disclosure provide a communication method. FIG. 2 is a schematic flowchart of a communication method 200 that can be applied to the system shown in FIG. 1 according to some embodiments of the present disclosure, but is not limited thereto. The method includes at least some of the following contents.

In S210, a first device schedules a second device to transmit sensing information, wherein transmission of the sensing information causes no interference to other devices.

In some embodiments, the first device described above is an initiator, and the second device is a responder.

In some embodiments, the sensing information is a sensing PPDU. At least the following three methods for scheduling the second device to transmit the sensing information is adopted in the present disclosure, such that the transmission of the sensing information causes no interference to the other devices.

Method 1:

The initiator schedules the responders that cause no interference to each other to transmit the sensing PPDU. For example, the initiator schedules the responders that cause no interference to each other to transmit the sensing PPDU simultaneously, or schedule the responders that cause no interference to each other to transmit the sensing PPDU sequentially.

Method 2:

The initiator schedules the responders to transmit the sensing PPDUs on beams/sectors causing no interference to each other. For example, the initiator schedules the responders to transmit the sensing PPDUs simultaneously on beams causing no interference to each other, or schedule the responders to transmit the sensing PPDUs sequentially on beams causing no interference to each other.

In some embodiments, the sector is also be referred to as a wide beam and the beam is also be referred to as a narrow beam.

Method 3:

The initiator schedules the responder to transmit the sensing PPDUs on different channels. For example, the initiator schedules the responders to transmit the sensing PPDUs on different channels simultaneously, or schedules the responders to transmit the sensing PPDUs on different channels sequentially.

To determine whether the responder interferes other devices, or whether the beam/sector of the sensing device interferes other devices, embodiments of the present disclosure adopt a method in which the initiator acquires the location information and/or the beam (or sector) direction information of each of the responders, and calculates the interference situation between two sensing devices based on the location information and/or the beam (or sector) direction information of each of the responders.

For example, the communication method provided in embodiments of the present disclosure further includes:

transmitting, by the first device, a request message to each of a plurality of second devices; and

receiving, by the first device, from the plurality of second devices, at least one of the location, the beam information, or the sector information of the plurality of second devices.

Taking the first device being the initiator and the second device being the responder as an example, FIG. 3 is a schematic diagram of an implementation of acquiring the location and beam/sector information of the responder according to some embodiments of the present disclosure. As shown in FIG. 3, in the DMG coordinated (monostatic or bistatic) sensing mode, the initiator (or an STA) transmits an information request frame or a probe request frame to the responder (or another STA) that supports providing the location and/or beam information, wherein the information request frame or the probe request frame is configured to request the location (e.g., location configuration information (LCI)) and beam/sector information of each responder. Each responder transmits an information response frame or a probe response frame back to the initiator, wherein the information response frame or the probe response frame is configured to carry the location and beam/sector information of the responder. It should be noted that the responder may use a wide beam at the sector level or a narrow beam at the beam level for DMG (monostatic or bistatic) sensing, and thus the embodiments of the present disclosure are designed for each of these two different levels (beam/sector).

In some embodiments, the information request frame or the probe request frame carries a first identifier and/or a second identifier, wherein the first identifier is an identifier for requesting to acquire a first relevant information element of the second device, and the second identifier is an identifier for requesting to acquire a second relevant information element of the second device. Then, the second device feeds back the first relevant information element and the second relevant information element to the first device, wherein the first relevant information element and the second relevant information element are configured to carry at least one of the location or beam information of the second device.

Alternatively, in some embodiments, the information request frame or the probe request frame carries a third identifier and/or a fourth identifier, wherein the third identifier is an identifier for requesting to acquire a third relevant information element of the second device, and the fourth identifier is an identifier for requesting to acquire a fourth relevant information element of the second device. Then, the second device feeds back the third relevant information element and the fourth relevant information element to the first device, wherein the third relevant information element and the fourth relevant information element are configured to carry at least one of the location or sector information of the second device.

Table 1 shows the format of an action field of the information request frame.

TABLE 1

| Order | Information |
|---|---|
| 1 | category |
| 2 | DMG action |
| 3 | subject address |
| 4 | request element |
| 5 | none or more DMG capabilities element |
| 6 | none or more provided element |
| 7 | none or more extended request element |
| 8 | none or more vendor specific request element |

The format of the action field of the probe request frame is similar to the Table 1.

In some embodiments, the request element (such as Order 4 in Table 1) or the extended request element (such as Order 7 in Table 1) in the information request frame or the probe request frame carries the above first identifier and/or second identifier, or carries the above third identifier and/or fourth identifier.

For example, in the extended request element of Order 7 (or request element of Order 4), the initiator indicates an identifier of an element of the responder that requested by the initiator, e.g., indicating an Element ID=x1 and a corresponding Element ID=y1, wherein indication of the Element ID=x1 and the Element ID=y1 is configured to request to acquire at least one of the location or beam information of the responder.

For another example, in the extended request elements of Order 7 (or request element of Order 4), the initiator indicates the identifier of the element of the responder that requested by the initiator, e.g., indicating an Element ID=x2 and a corresponding Element ID=y2, wherein indication of the Element ID=x2 and the Element ID=y2 is configured to request to acquire at least one of the location or sector information of the responder.

Table 2 shows the format of the action field of the information response frame.

TABLE 2

| Order | Information |
|---|---|
| 1 | category |
| 2 | DMG action |
| 3 | subject address |
| 4 | none or more DMG capabilities element |
| 5 | none or more requested element |
| 6 | none or more provided element |

The format of the action field of the probe response frame is similar to the Table 2.

In some embodiments, the second device transmits an information response frame or a probe response frame to the first device, wherein a sensing beam element and/or a sensing beam description element is carried in a requested element (e.g., Order 5 in the Table 2) in the information response frame or the probe response frame, wherein the sensing beam element and/or a sensing beam description element is configured to provide location and/or beam information of the second device to the first device; or a sensing sector element and/or a sensing sector description element is carried in a requested element (e.g., Order 5 in the Table 2) in the information response frame or the probe response frame, wherein the sensing sector element and/or the sensing sector description element is configured to provide location and/or sector information of the second device to the first device.

For example, the first device receives the information response frame or the probe response frame from the second device.

The information response frame or the probe response frame includes a sensing beam element and a sensing beam description element, wherein the sensing beam element carries a first identifier and further carries the number of beams for sensing configured by the second device and/or location information of the second device. The sensing beam description element carries a second identifier and beam information of each of the beams of the second device.

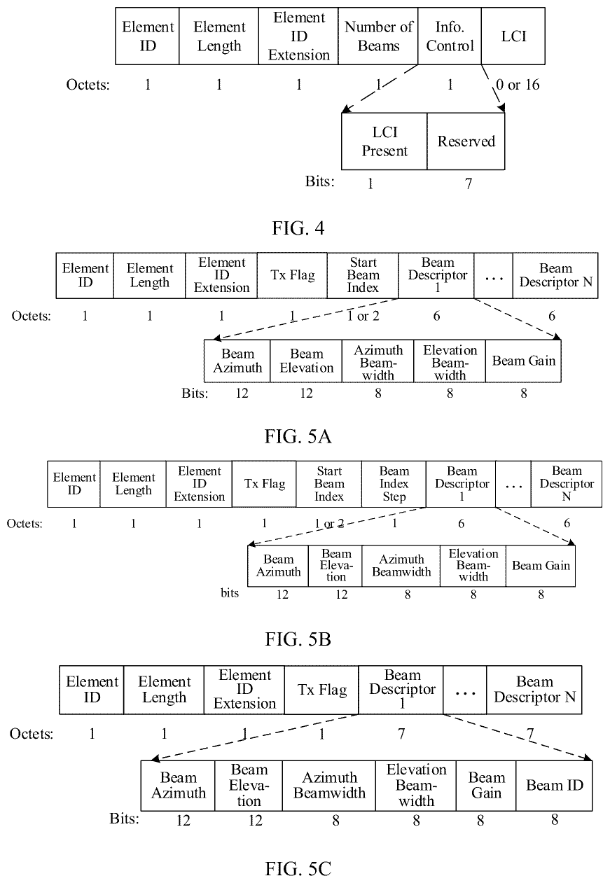

FIG. 4 is a schematic structural diagram of a sensing beam element according to some embodiments of the present disclosure. As shown in FIG. 4, in the case that the initiator requests the responder to feedback beam level information, a DMG coordinated (monostatic or bistatic) sensing beam element with Element ID=x1 is newly designed, wherein the DMG coordinated (monostatic or bistatic) sensing beam element with Element ID=x1 indicates the number of beams used for DMG coordinated (monostatic or bistatic) sensing and/or location information of the responder. FIGS. 5A to 5C are schematic structural diagrams of three sensing beam description elements according to some embodiments of the present disclosure. As shown in FIGS. 5A to 5C, in the case that the initiator requests the responder to feedback beam level information, a sensing beam description element with Element ID=y1 is newly designed, wherein the sensing beam description element with Element ID=y1 indicates specific parameters of each beam used for DMG coordinated (monostatic or bistatic) sensing.

In some embodiments, the sensing beam element includes at least one of:

an element identifier (ID) field;

an element length field;

an element ID extension field, configured to carry the first identifier;

a number of beams field, configured to carry the number of beams for sensing configured by the second element; an information (Info.) control field; or

an LCI field, configured to carry location information of the second device.

Taking FIG. 4 as an example, the sensing beam element includes the following information:

the element ID: indicating an identifier of the sensing beam element, e.g., with a value of 255;

the element length: indicating a length of the sensing beam element;

the element ID extension: indicating the extended element ID in the case that Element ID=255, e.g., with the above value x1, which can be any value ranging from 94 to 255;

the number of beams: indicating a total number of beams (for DMG coordinated monostatic/bistatic sensing) supported by the responder;

the Info. control: including a 1 bit LCI present subfield, wherein the LCI present subfield indicates whether the LCI field is present in the DMG coordinated (monostatic or bistatic) sensing beam element, e.g., LCI present subfield=1 indicating that the LCI field is present in the DMG coordinated (monostatic or bistatic) sensing beam element, otherwise the LCI field is not present; alternatively, LCI present subfield=0 indicating that the LCI field is present in the DMG coordinated (monostatic or bistatic) sensing beam element, otherwise the LCI field is not present; and

the LCI: indicating location information of the responder.

In some embodiments, the sensing beam description element includes at least one of:

an element ID field;

an element length field;

an element ID extension field, configured to carry the second identifier;

a transmit (Tx) indication field, configured to indicate beam information of a transmit beam or a receive beam carried by the sensing beam description element;

a start beam index field, configured to indicate an identifier of a 1st beam carried by the sensing beam description element;

a beam index step field, configured to indicate a step between beam IDs carried by the sensing beam description element; and

a plurality of first beam descriptors, wherein each of the plurality of first beam descriptors carries beam information of one beam.

Taking FIG. 5A as an example, a sensing beam description element includes the following information:

an element ID: indicating an identifier of the sensing beam description element, e.g., with a value of 255;

an element length: indicating the length of the sensing beam description element;

an element ID extension: indicating the extended Element ID in the case that Element ID=255, e.g., with the above value y1, which can be any value ranging from 94 to 255 and differing from x1;

a Tx flag: indicating whether the current sensing beam description element carries information of the transmit beam or information of the receive beam, e.g., Tx Flag=1 represents the transmit beam and Tx Flag=0 represents the receive beam; alternatively, Tx Flag=1 represents the receive beam and Tx Flag=0 represents the transmit beam;

a start beam index: indicating the number of the 1st beam carried by the current sensing beam description element (i.e., beam descriptor 1), wherein the ID of the beam indicated by the Nth beam descriptor can be inferred from the start beam index and N, e.g. start beam index+N-1;

a beam descriptor 1 to N: indicating the orientation information of the 1st to Nth beam, which can include the following information:

a beam azimuth subfield and a beam elevation subfield, which include the azimuth and elevation of the beam respectively; wherein the beam azimuth subfield is specified in 360°/4096 units and takes values from 0 to 4095, and the beam elevation subfield is 2′s complement taking values from-2048 to 2047 in 180°/4096 units;

an azimuth beamwidth subfield and an elevation beamwidth subfield, wherein the azimuth beamwidth subfield and the elevation beamwidth subfield include the beam 3 dB bandwidth in azimuth and elevation respectively in 180°/256; and

a beam gain subfield, wherein the beam gain subfield includes a beam gain in 0.5 dB units.

In the above example, the sensing beam description element carries the orientation and gain information of a plurality of beams, and the Nth beam descriptor's number is inferred/implicitly acquired by combining the start beam ID with the number N, e.g., the beam descriptor's number=start beam ID+N−1. In this case, the transmitter and/or receiver starts with the start beam ID and performs transmitting and/or receiving on its supported beams in sequence.

In the example shown in FIG. 5B, another implementation is designed. For example, the start beam index indicates the ID of the 1st beam, and the beam index step field indicates the number of beam indexes of subsequent beam descriptors stepped (jumped) in the list (e.g., x). For example, in the case that start beam index=1 and beam index step=x, the beam descriptor 1 indicates information related to beam index=1, beam descriptor=2 indicates information related to Beam Index=1+x, and beam descriptor N indicates information related to beam index=1+ (N−1)*x. In this case, the transmitter and/or receiver can traverse the beam at the step of x. Compared with the example shown in FIG. 5A, the present example speeds up the beam searching.

The sensing beam description element shown in FIG. 5B includes the following information:

an element ID;

an element length;

an element ID extension;

a Tx flag;

wherein the above portions are the same as the corresponding portions shown in FIG. 5A and not repeated herein;

a start beam index: indicating the number of the 1st beam carried by the current sensing beam description element (i.e. beam descriptor 1);

a beam index step: indicating the step of the index of the beam indicated by the sensing beam description element; wherein the ID of the beam indicated by the Nth beam descriptor can be inferred from the start beam index, the beam index step, and the N, such as start beam index+(N−1)*beam index step; and

beam descriptor 1 to N, wherein these portions are the same as the corresponding portions shown in FIG. 5A and not repeated herein.

In another embodiment, the sensing beam description element includes at least one of:

an element ID field;

an element length field;

an element ID extension field, configured to carry the second identifier;

a transmit indication field, configured to indicate beam information of the transmit beam or the receive beam carried by the sensing beam description element; and

a plurality of second beam descriptors, wherein each of the plurality of second beam descriptors carries beam information of one beam and an identifier of the beam.

Taking FIG. 5C as an example, the sensing beam description element includes the following information:

an element ID;

an element length;

an element ID extension;

a Tx flag;

wherein the above portions are the same as the corresponding portions shown in FIG. 5A and not repeated herein;

beam descriptors 1 to N: indicating the azimuth information and beam ID of the 1st to Nth beam, which can include the following information:

a beam azimuth subfield and a beam elevation subfield, wherein the beam azimuth subfield and the beam elevation subfield include the azimuth and elevation of the beam respectively, and the beam azimuth subfield and beam elevation subfield are specified in the same manner as the examples shown in FIG. 5A and not repeated herein;

an azimuth beamwidth subfield and an elevation beamwidth subfield, wherein the azimuth beamwidth subfield and the elevation beamwidth subfield include the beam 3 dB bandwidth in azimuth and elevation respectively in 180°/256;

a beam gain subfield, wherein the beam gain subfield includes the beam gain in 0.5 dB units; and

a beam ID, wherein the beam ID carries the index of the beam.

In this example, instead of indicating the start beam ID, the beam ID corresponding to the descriptor is explicitly indicated in each beam descriptor. In this case, the transmitter and/or receiver can realize not only transmitting/receiving on its supported beams in sequence, but also transmitting/receiving at a step of x beams, and quickly searching for the beams given in the list by other beam search algorithms (e.g., bisection).

In some embodiments, the first device receives an information response frame or a probe response frame from the second device.

The information response frame or the probe response frame includes a sensing sector element and a sensing sector description element. The sensing sector element carries a third identifier and further carries the number of sectors for sensing configured by the second device and/or location information of the second device. The sensing sector description element carries a fourth identifier and beam information of each of the sectors of the second device.

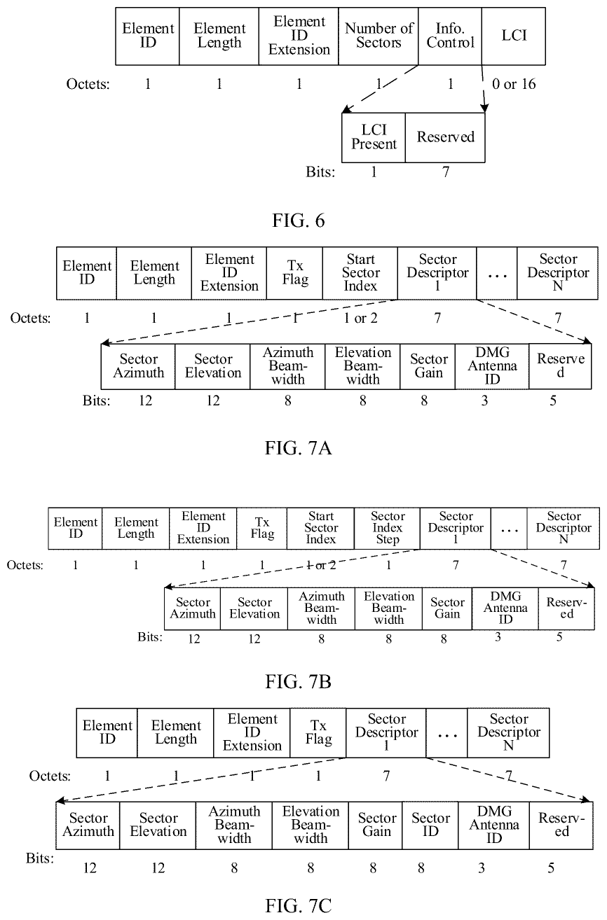

FIG. 6 is a schematic structural diagram of a sensing sector element according to some embodiments of the present disclosure. As shown in FIG. 6, in the case that the initiator requests the responder to feedback sector level information, a DMG coordinated (monostatic or bistatic) sensing sector element with Element ID=x2 is newly designed, wherein the DMG coordinated (monostatic or bistatic) sensing sector element with Element ID=x2 indicates the number of sectors used for DMG coordinated (monostatic or bistatic) sensing and/or the location information of the responder. FIGS. 7A to 7C are schematic structural diagrams of three sensing sector description elements according to some embodiments of the present disclosure. As shown in FIGS. 7A to 7C, in the case that the initiator requests the responder to feedback the sector level information, a sensing sector description element with Element ID=y2 is newly designed, wherein the sensing sector description element with Element ID=y2 indicates specific parameters of each sector used for DMG coordinated (monostatic or bistatic) sensing.

In some embodiments, the sensing sector element includes at least one of:

an element ID field;

an element length field;

an element ID extension field, configured to carry a third identifier;

a number of beams field, configured to carry the number of sectors for sensing configured by the second device;

an Info. control field; or

an LCI field, configured to carry location information of the second device.

Taking FIG. 6 as an example, the sensing sector element includes the following information:

an element ID: indicating an identifier of the sensing sector element, e.g., with a value of 255;

an element length: indicating a length of the sensing sector element;

an element ID extension: indicating an extended element ID in the case that Element ID=255, e.g. with the above value x2, which can be any value ranging from 94 to 255 and differing from x1 and y1;

the number of sectors: indicating a total number of sectors (for DMG coordinated monostatic/bistatic sensing) supported by the responder;

the Info. control: including a 1 bit LCI present subfield, wherein the LCI present subfield indicates whether the LCI field is present in the DMG coordinated (monostatic or bistatic) sensing sector element, for example, LCI present subfield=1 indicates that the LCI field is present in the DMG coordinated (monostatic or bistatic) sensing sector element, otherwise the LCI field is not present; alternatively, LCI present subfield=0 indicates that the LCI field is present in the DMG coordinated (monostatic or bistatic) sensing sector element, otherwise the LCI field is not present; and

an LCI: indicating location information of the responder.

In some embodiments, the sensing sector description element includes at least one of:

an element ID field;

an element length field;

an element ID extension field, configured to carry the fourth identifier;

a transmit indication field, configured to indicate the sector information of the transmit sector or the receive sector carried by the sensing sector description element;

a start sector index field, configured to indicate the ID of the 1st sector carried by the sense sector description element;

a sector index step field, configured to indicate a step between sector identifications carried by the sense sector description element; and

a plurality of first sector descriptors, wherein each of the plurality of first sector descriptors carries sector information and a DMG antenna ID of one sector.

Taking FIG. 7A as an example, the sensing sector description element includes the following information:

an element length: indicating a length of the sensing sector description element;

an element ID extension: indicating an extended element ID in the case that Element ID=255, e.g., with the value y2, which can be any value ranging from 94 to 255 and differing from x1, y1 and x2;

a Tx flag: indicating whether the current sensing sector description element carries information of the transmit sector or information of the receive sector, for example, Tx flag=1 represents the transmit sector and Tx flag=0 represents the receive sector; alternatively, Tx flag=1 represents the receive sector and Tx flag=0 represents the transmit sector;

a start sector index: indicating the number of the 1st sector carried by the current sensing sector description element (i.e., sector descriptor 1), wherein the ID of the sector indicated by the Nth sector descriptor can be inferred from the start sector index and N, e.g. start sector index+N−1;

sector descriptors 1 to N: indicating azimuth information of the 1st to Nth sector, which can include the following information:

a sector azimuth subfield and a sector elevation subfield, wherein the sector azimuth subfield and the sector elevation subfield include the azimuth and elevation of the sector respectively; the sector azimuth subfield is specified in 360°/4096 units and takes values from 0 to 4095; and the sector elevation subfield is 2's complement taking values from −2048 to 2047 in 180°/4096 units;

an azimuth beamwidth subfield and an elevation beamwidth subfield, wherein the azimuth beamwidth subfield and the elevation beamwidth subfield include the beam 3 dB bandwidth in azimuth and elevation respectively in 180°/256;

a sector gain subfield, wherein the sector gain subfield includes the sector gain in 0.5 dB units; and

a DMG antenna ID, wherein the DMG antenna ID is equal to a DMG antenna ID used in beacon using the azimuth and elevation described.

In the above example, the sensing sector description element carries the orientation and gain information of a plurality of sectors, and the Nth sector descriptor's number is inferred/implicitly acquired by combining the start sector ID and the number N, e.g., the sector descriptor's number=start sector ID+N−1. In this case, the transmitter and/or receiver starts with the start sector ID and performs transmitting and/or receiving on its supported sectors in sequence.

In the example shown in FIG. 7B, another implementation is designed, for example, the start sector index indicates the ID of the 1st sector, and the sector index step field indicates the number of sector indexes of subsequent sector descriptors stepped (jumped) in the list (e.g., x). For example, in the case that start sector index=1 and sector index step=x, sector descriptor 1 indicates information related to sector index=1, sector descriptor=2 indicates information related to sector index=1+x, and sector descriptor N indicates information related to sector index=1+(N−1)*x. In this case, the transmitter and/or receiver can traverse the sectors at the step of x. Compared with the example shown in FIG. 7A, the present example speeds up the sector searching.

The sensing sector description element shown in FIG. 7B includes the following information:

an element ID;

an element length;

an element ID extension;

a Tx flag;

wherein the above portions are the same as the corresponding portions shown in FIG. 7A and not repeated herein;

a start sector index: indicating the number of the 1st sector carried by the current sensing

sector description element (i.e., sector descriptor 1);

a sector index step: indicating the step of the index of the sector indicated by the sensing sector description element; wherein the ID of the sector indicated by the Nth sector descriptor can be inferred from the start sector index, the sector index step and the N, such as start sector index+(N−1)*sector index step; and

sector descriptors 1 to N, wherein these portions are the same as the corresponding portions shown in FIG. 7A and not repeated herein.

In another embodiment, the sensing sector description element includes at least one of:

an element ID field;

an element length field;

an element ID extension field, configured to carry a fourth identifier;

a transmit indication field, configured to indicate sector information of the transmit sector or the receive sector carried by the sensing sector description element;

a plurality of second sector descriptors, wherein each of the plurality of second sector descriptors carries sector information, a DMG antenna ID and an identifier of one sector.

Taking FIG. 7C as an example, the sensing sector description element includes the following information:

an element ID;

an element length;

an element ID extension;

a Tx flag;

wherein the above portions are the same as the corresponding portions shown in FIG. 7A and not repeated herein;

sector descriptors 1 to N: indicating the azimuth information and sector ID of the 1st to Nth sector, which can include the following information:

a sector azimuth subfield and a sector elevation subfield, wherein the sector azimuth subfield and the sector elevation subfield include the azimuth and the elevation of the sector respectively, and the sector azimuth subfield and the sector elevation subfield are specified in the same manner as the examples shown in FIG. 7A and not repeated herein;

an azimuth beamwidth subfield and an elevation beamwidth subfield, wherein the azimuth beamwidth subfield and the elevation beamwidth subfield include the beam 3 dB bandwidth in azimuth and elevation respectively in 180°/256;

a sector gain subfield, wherein the sector gain subfield includes a sector gain in 0.5 dB units;

a sector ID, wherein the sector ID carries the index of the sector; and

a DMG antenna ID, wherein the DMG antenna ID is equal to the DMG antenna ID used in the beacon using the azimuth and elevation described.

In this example, instead of indicating the start sector ID, the sector ID corresponding to the descriptor is explicitly indicated in each sector descriptor. In this case, the transmitter and/or receiver can realize not only transmitting/receiving on its supported sectors in sequence, but also transmitting/receiving at a step of x sectors, and quickly searching for the sectors given in the list by other sector search algorithms (e.g., bisection).

The above describes several implementations of the first device (e.g., initiator) acquiring location information and/or beam (or sector) information of each of the second devices (e.g., responders). Utilizing the location information and/or beam (or sector) information of each of the second devices (e.g., responders), the first device can calculate interference between different second devices, or between each of the second devices and the first device.

In some embodiments, the communication method according to the embodiments of the present disclosure further includes:

determining, by the first device and based on at least one of the location, the beam information, or the sector information of a plurality of second devices, a strength of interference caused by the transmit beam/sector of each of the second devices to the receive beam/sectors of the other devices; and

determining, by the first device, that the transmit beam/sector of the second device causes no interference to the other devices in the case that the strength of interference caused by the transmit beam/sector of the plurality of second devices to the receive beams/sectors of the other devices is less than or equal to a first threshold; or determining, by the first device, that the second device causes no interference to the other devices in the case that the strength of interference caused by the transmit beams/sectors of each of the plurality of second devices to the receive beams/sectors of the other devices is less than or equal to the first threshold.

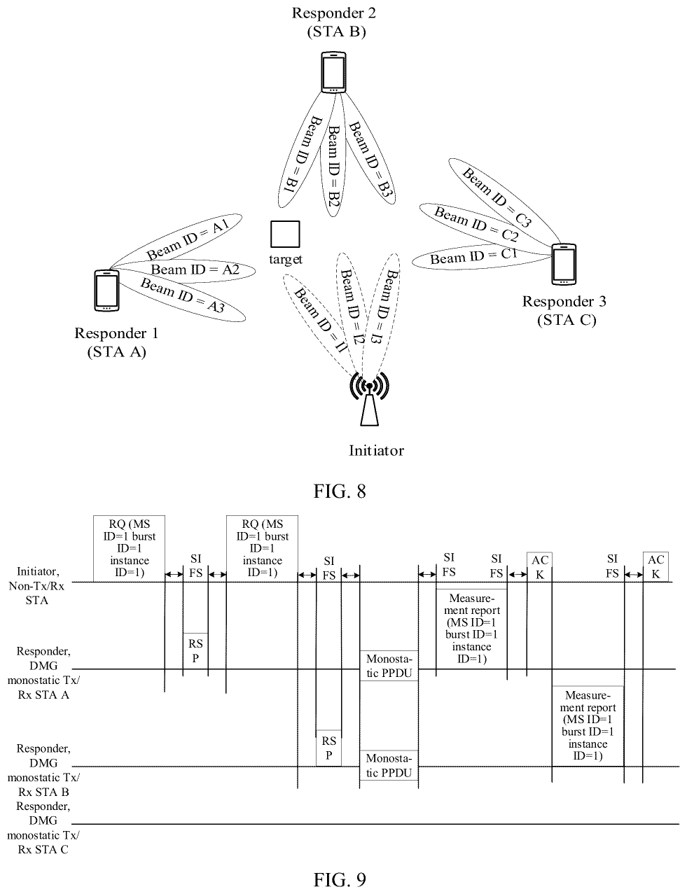

The DMG coordinated sensing network topology (in monostatic mode or bistatic mode) is shown in FIG. 8. It should be noted that, with respect to the DMG coordinated monostatic sensing mode, the initiator is generally an AP and does not need to transmit monostatic PPDUs, and the initiator schedules the other stations to transmit monostatic PPDUs. For example, as shown in FIG. 8, the initiator schedules the other stations to transmit monostatic PPDUs. For example, the initiator schedules STA A to transmit monostatic PPDUs, and the STA A receives the monostatic PPDUs from itself, and then uses the monostatic PPDUs for sensing detection. With respect to the DMG coordinated bistatic sensing, the initiator may be a transmitting device or a receiving device of a bistatic PPDU to participate in DMG coordinated bistatic sensing. For example, in FIG. 8, the initiator transmits a bistatic PPDU, the STA A receives the bistatic PPDU, and uses the bistatic PPDU for sensing detection. The initiator schedules STA B to transmit a bistatic PPDU, STA C receives the bistatic PPDU, and then uses the bistatic PPDU for sensing detection.

Through the information interaction between the first device (e.g., the initiator) and the second device (e.g., the responder) in the preceding examples, the initiator acquires the location information of each of the responders and/or the beam/sector direction information of the responders, and determines the strength of interference caused by the transmit beams/sector of each of the plurality of second devices (e.g., the responders) to the receive beams/sectors of the other devices based on at least one of:

a transmit power of the second device;

a transmit gain of the transmit beam/sector of the second device;

a receive gain of the receive beam/sector of the other device;

angle information of the transmit beam/sector of the second device;

angle information of the receive beam/sector of the other device; or

a path loss of a signal from the second device to the other device, wherein the path loss is related to a location of the second device and a location of the other device.

In some embodiments, the angle information includes at least one of an elevation, an azimuth, an elevation beamwidth, or an azimuth beamwidth.

Taking the STA A and the STA B in FIG. 8 as an example, the strength of interference caused by a receive beam ID (or sector ID)=Bi received by the STA B to a transmit beam ID (or sector ID)=Ai from the STA A is expressed as equation (1):

$${I}_{Rx , Bi}^{Tx , Ai} [ dBm ] = {P}_{Tx}^{S T A A} \cdot {G}_{T x}^{A i} \cdot {G}_{R x}^{B i} \cdot K ( {α}_{T x}^{A i} , {θ}_{T x}^{A i} , {α}_{T x}^{3 d B , Ai} , {θ}_{T x}^{3 d B , Ai} ; {α}_{R x}^{B i} , {θ}_{R x}^{B i} , {α}_{R x}^{3 d B , B i} , {θ}_{R x}^{3 d B , Bi} ) [ dBm ] - PL ( STA A , STA B ) [ dB ] \qquad ( 1 )$$

wherein P_{Tx}^{STA A} indicates the transmit power of the STA A, G_{Tx}^{Ai} indicates the transmit beam/sector gain corresponding to the beam ID (or sector ID)=Ai of the STA A, GB_{Rx}^{Bi} indicates the receive beam/sector gain corresponding to the beam ID (or sector ID)=Bi of the STA B, K(·) indicates a loss of directional transmission of the signal at a given angle (offset), α_{Tx}^{Ai}, θ_{Tx}^{3dB,Ai}, α_{Tx}^{3dB,Ai}, θ_{Tx}^{3dB, Ai}, indicate the elevation, the azimuth, the elevation beamwidth, and the azimuth beamwidth of the transmit beam/sector with ID=Ai of the STA A respectively, α_{Rx}^{Bi}, θ_{Rx}^{Bi}, α_{Rx}^{3dB,Bi}, θ_{Rx}^{3dB,Bi} indicates the azimuth, the elevation, the azimuth beamwidth, the elevation beamwidth of the receive beam/sector with ID=Bi of the STA B respectively, and PL (STA A, STA B) indicates the path loss of the signal from the STA A to the STA B.

The strength of interference (I) caused by the transmit beams/sectors of any one transmitting device to the receive beams/sectors of the other devices can be traversed to acquire by equation (1). The threshold (Y) can be set. In the case that I>γ, it is considered that the strength of interference is large and the (monostatic/bistatic) sensing PPDUs from the transmitting device affect the reception of the other devices. Otherwise, it is considered that the strength of interference is small and the (monostatic/bistatic) sensing PPDUs from the transmitting device do not affect the reception of the other devices. Because two or more transmitting devices may transmit the monostatic/bistatic sensing PPDUs simultaneously in DMG coordinated (monostatic or bistatic) sensing mode, the interference may occur and affect the reception of DMG coordinated (monostatic or bistatic) sensing results. To solve this problem, some embodiments of the present disclosure provide a method for scheduling DMG coordinated (monostatic or bistatic) sensing, such as the above methods 1 to 3.

These three scheduling methods are described in detail hereinafter in conjunction with the accompanying drawings and embodiments.

Method 1: The initiator schedules the responders that cause no interference to each other to transmit the sensing PPDU.

This method can be applicable to a scenario in which the sensing devices are sparsely distributed and distant from each other. In this scenario, the transmitting signals of the sensing devices generally do not cause a large interference to each other, and the initiator (AP/STA) can schedule these devices that cause no interference to each other to transmit sensing PPDUs simultaneously.

In some embodiments, scheduling the second device to transmit the sensing information includes: scheduling the second device that causes no interference to the other devices to transmit the sensing information.

For example, the first device schedules the second device that causes no interference to the other devices and the other devices to transmit the sensing information simultaneously; or the first device schedules the second device that causes no interference to the other devices and the other devices to transmit the sensing information sequentially.

Corresponding to the DMG coordinated monostatic sensing mode, the first device schedules a plurality of second devices to transmit the sensing information, and any one of the plurality of second devices causes no interference to the other second devices.

Taking the system shown in FIG. 8 as an example, the initiator (non-Tx/receive (Rx) STA, which may be an AP) requests location and/or direction information of the beams of the STA A, the STA B, and the STA C sequentially over the information request frame, and then calculates strength of interference caused by any beams/sectors of any two stations of the STA A, the STA B, and the STA C.

In the case that the calculated strength of interference (I) between two STAs (e.g., the STA A and the STA C, or the STA B and the STA C) is greater than the threshold (y), the two STAs are not scheduled to transmit the monostatic sensing PPDUs simultaneously, but the two STAs may be scheduled to transmit the monostatic sensing PPDUs sequentially.

In the case that the strength of interference (I) between two STAs (e.g., the STA A and the STA B) is calculated to be less than a threshold (γ), the two STAs are scheduled to transmit the monostatic sensing PPDUs simultaneously, or the two STAs are scheduled to transmit the monostatic sensing PPDUs sequentially.

FIG. 9 is a flowchart of an implementation of scheduling STAs causing no interference to each other and transmitting sensing PPDUs simultaneously in a DMG coordinated monostatic sensing scenario according to some embodiments of the present disclosure. In the example of FIG. 9, the signaling process of the initiator scheduling the STA A and the STA B to transmit the monostatic sensing PPDUs simultaneously is given as an example, wherein the STA A and the STA B cause no interference to each other (but the STA A and the STA C, and the STA B and the STA C cause interference to each other). It can be seen that the initiator can schedule the STA A and the STA B to transmit the monostatic sensing PPDUs simultaneously, because the STA A and the STA B cause no interference to each other.

Corresponding to the DMG coordinated bistatic sensing mode, the first device schedules one or more second devices to transmit the sensing information, and any one of the one or more second devices causes no interference to the first device and/or the other second devices.

Taking the system shown in FIG. 8 as an example, the initiator (Tx/Rx STA, STA) requests the location and/or the direction information of the beams of the STA A, the STA B, and the STA C sequentially over the information request frame, and then calculates strengths of interference caused by any beams/sectors of any two the STAs of the STA A, the STA B, and the STA C.

In the case that the strength of interference (I) caused by the transmitter (e.g., the initiator) of a bistatic (e.g., the initiator and the STA A) to the receiver (e.g., the STA C) of another bistatic (e.g., the STA B and the STA C) is greater than a threshold (y), then the STA B is not scheduled to transmit the bistatic sensing PPDUs with the initiator simultaneously, but the STA B may be scheduled to transmit the bistatic sensing PPDUs at a different time from the initiator.

In the case that the strength of interference (I) caused by the transmitter (e.g., initiator) of a bistatic (e.g., initiator and the STA A) to the receiver (e.g., the STA C) of another bistatic (e.g., the STA B and the STA C) is less than the threshold (γ), and the strength of interference (I) caused by the transmitter (e.g., the STA B) of bistatic (e.g., the STA B and the STA C) to the receiver (e.g., the STA A) of bistatic (e.g., the initiator and the STA A) is also less than the threshold (γ), the STA (i.e., the STA B) is scheduled to transmit the bistatic sensing PPDUs with the initiator simultaneously, or the STA (i.e., the STA B) is scheduled to transmit the bistatic sensing PPDUs with the initiator sequentially.

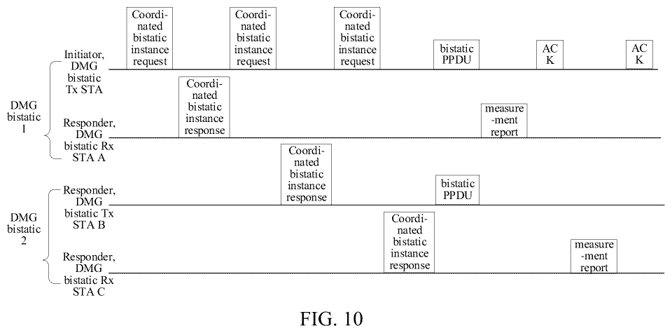

FIG. 10 is a flowchart of an implementation of scheduling STAs causing no interference to each other and transmitting sensing PPDUs simultaneously in a DMG coordinated bistatic sensing scenario according to some embodiments of the present disclosure. In the example of FIG. 10, taking that the initiator and the STA B cause no interference to each other's receivers as an example, the signaling process of the initiator scheduling the STA B to transmit the monostatic sensing PPDUs simultaneously is given as an example. It can be seen that because the initiator and the STA B cause no interference to each other's receivers, the initiator can schedule the STA B to transmit bistatic sensing PPDU with the initiator simultaneously.

Method 2: the initiator schedules the responder to transmit sensing PPDUs simultaneously on beams that cause no interference to each other.

This method can be applied to the scenario where the sensing devices are densely distributed and closer to each other. In this scenario, the transmitting signals of the sensing devices cause greater interference to each other, and the initiator (AP/STA) can schedule any two or more responders (with or without interference with each other) to transmit the monostatic sensing PPDUs simultaneously on beams/sectors that cause no interference to each other.

In some embodiments, scheduling the second device to transmit sensing information includes:

assigning a beam/sector that causes no interference to the other devices to the second device; and

scheduling the second device to transmit the sensing information on the beam/sector that causes no interference to the other devices.

For example, the first device schedules the second and the other devices device to transmit the sensing information simultaneously; or the first device schedules the second device and the other devices to transmit the sensing information sequentially.

Similar to the method 1, the method 2 also involves the DMG coordinated monostatic sensing mode and the DMG coordinated bistatic sensing mode.

In some embodiments, corresponding to the DMG coordinated monostatic sensing mode, the first device assigns a transmit beam/sector that causes no interference to the other second devices to each of the plurality of second devices, and/or the first device assigns a receive beam/sector that suffers no interference from the other second devices to each of the plurality of second devices, and the first device schedules the plurality of second devices to transmit and/or receive the sensing PPDUs on the assigned beams/sectors.

In some embodiments, corresponding to the DMG coordinated bistatic sensing mode, the first device assigns transmit a beam/sector that causes no interference to the first device and/or the other second devices to each of the one or more second devices, and/or the first device assigns a receive beam/sector that suffers no interference from the first device and/or the other second devices to each of the one or more second devices, and the first device schedules the one or more second devices to transmit and/or receive the sensing PPDUs on the assigned beams/sectors.

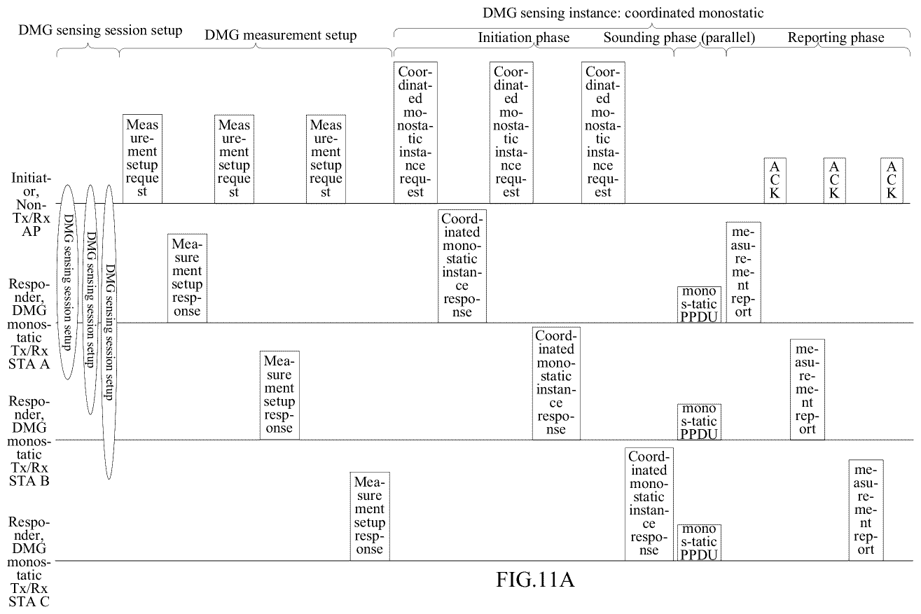

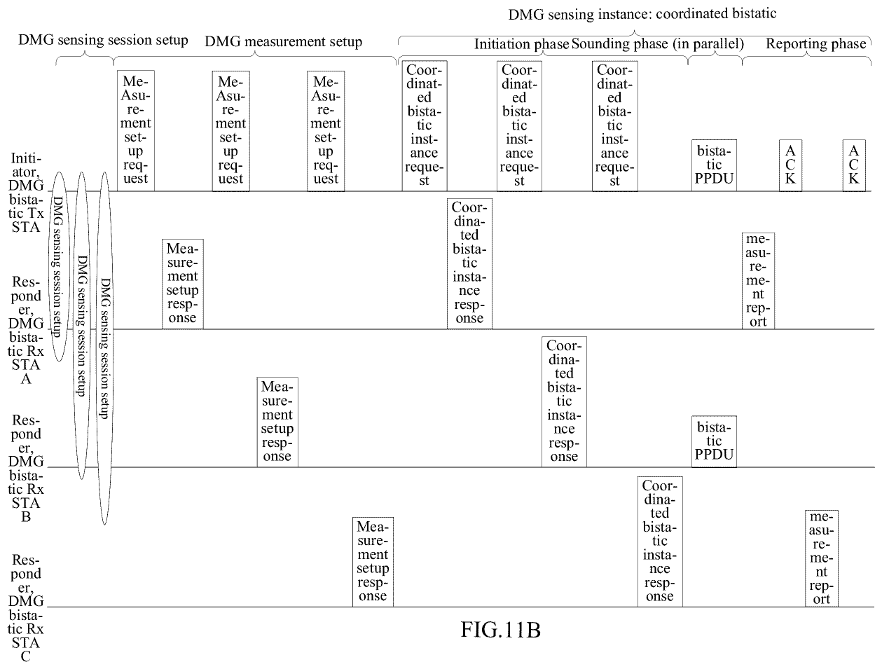

FIG. 11A is a flowchart of a DMG coordinated monostatic sensing according to some embodiments of the present disclosure, and FIG. 11B is a flowchart of a DMG coordinated bistatic sensing according to some embodiments of the present disclosure. As shown in FIGS. 11A and 11B, with respect to the DMG coordinated monostatic sensing mode and the DMG coordinated bistatic sensing mode, the initiator first performs a DMG sensing session setup with each of the responders. In this phase, the initiator interacts with each of the responders for capabilities, for example, initiator can know whether the STA A, the STA B, and the STA C support DMG coordinated monostatic/bistatic sensing. Then initiator and the responder supporting DMG coordinated monostatic/bistatic sensing configure the role information, sense the category of measurement, and sense scheduling information of each of the responders by performing DMG measurement setup. Then, the DMG sensing instance is performed.

Referring to FIG. 11A, in the DMG coordinated monostatic sensing process, the DMG sensing instance phase includes the following phases.

Initiation phase: The initiator transmits a coordinated monostatic instance request frame to the responder participating in DMG coordinated monostatic sensing, and then the responder replies a coordinated monostatic instance response frame.

Sounding phase: The responders transmit monostatic PPDUs simultaneously or at separate time. For example, in the example shown in FIG. 11A, upon assigning the transmit beams/sectors that cause no interference to the other devices to the STA A, the STA B, and the STA C, the initiator schedules the STA A, the STA B, and the STA C to transmit monostatic PPDUs on the beams/sectors simultaneously.

Reporting phase: Each of the responders reports the sensing result to the initiator.

Referring to FIG. 11B, the DMG sensing instance phase in the DMG coordinated bistatic sensing process includes the following phases.

Initiation phase: The initiator transmits a coordinated bistatic instance request frame to the responder participating in DMG coordinated bistatic sensing, and the responder replies a coordinated bistatic instance response frame.

Sounding phase: The transmitters (e.g., the initiator and the STA B) transmits bistatic PPDUs simultaneously or at separate time. For example, in the example shown in FIG. 11B, upon assigning the transmit beams/sectors that cause no interference to the other devices to the initiator and the STA B, the STA B is scheduled to transmit bistatic PPDU on the transmit beam/sector with the initiator simultaneously.

Reporting phase: Each of the receivers (e.g., the STA A and the STA C) reports the sensing result to the initiator.

It should be noted that the phase of the initiator acquiring the location information and/or beam direction information of the responder and the phase of the initiator calculating the interference between the responders described above may occur upon the DMG sensing session setup and prior to the DMG measurement setup; alternatively, the phase of the initiator acquiring the location information and/or beam direction information of the responder and the phase of the initiator calculating the interference between the responders described above may occur upon the measurement setup and prior to the DMG sensing instance. In the following, the embodiments of the present disclosure design a method for assigning beams for each of the above two cases.

With respect to the beam/sector assignment, the embodiments of the present disclosure perform the beam/sector assignment in at least two phases, i.e., the DMG measurement setup phase and the DMG sensing instance phase.

For example, the first device transmits a DMG measurement setup request frame to the second device, wherein the DMG measurement setup request frame indicates a beam/sector that causes no interference to the other devices; and/or

the first device transmits a coordinated monostatic/bistatic instance request frame to the second device, wherein the coordinated monostatic/bistatic instance request frame indicates the beam/sector that causes no interference to the other devices.

The information indicated by the coordinated monostatic/bistatic instance request frame is configured to update the information indicated by the DMG measurement setup request frame, in the case that the first device performs beam assignment in both of the preceding phases, i.e., in the case that the first device transmits the DMG measurement setup request frame and the coordinated monostatic/bistatic instance request frame to the second device.

The following describes each of these two beam assignment methods.

Assignment Method 1:

The initiator assigns beams causing no interference to each other to the responders in the DMG measurement setup phase.

Referring to the scenario shown in FIG. 8, in the case that the initiator calculates the beams/sectors that cause no interference to each other among the initiator, the STA A, the STA B and the STA C upon the DMG sensing session setup and prior to the DMG measurement setup,

with respect to the DMG coordinated monostatic sensing mode, initiator can use the Tx beam/sector list subelement in the DMG measurement setup request frame to indicate which beams/sectors can be used by the STA A, the STA B, and the STA C to transmit the monostatic sensing PPDUs simultaneously without causing interference to each other;

with respect to the DMG coordinated bistatic sensing mode, the initiator can use the Tx beam/sector list subelement in the DMG measurement setup request frame to indicate which beams/sectors can be used by the STA B to transmit bistatic sensing PPDUs with the initiator simultaneously without causing interference to the reception of the STA A. In addition, the initiator can use the Rx beam/sector list subelement in the DMG measurement setup request frame to indicate which beams/sectors can be used by the STA A and the STA C to receive bistatic sensing PPDUs.

It should be noted that the methods that the initiator uses the transmit beam/sector list subelement in the DMG measurement setup request frame to indicate which beams/sectors can be used by the responders to transmit monostatic/bistatic sensing PPDUs, and/or uses the receive beam/sector list subelement to indicate which beams/sectors can be used by the responders to receive monostatic/bistatic sensing PPDUs, can also be applied to the scenario that initiator schedules the responders to sequentially transmit the monostatic/bistatic sensing PPDUs.

In some embodiments, the DMG measurement setup request frame indicating the beam/sector that causes no interference to the other devices includes the following scenario:

the DMG measurement setup request frame includes a DMG sensing measurement setup element, wherein the DMG sensing measurement setup element includes optional subelements, the optional subelements include at least one of the Tx beam/sector list subelement or the Rx beam/sector list subelement; wherein

the Tx beam/sector list subelement indicates the transmit beam/sector that causes no interference to the other devices; and

the Rx beam/sector list subelement indicates the receive beam/sector that suffers no interference from the other devices.

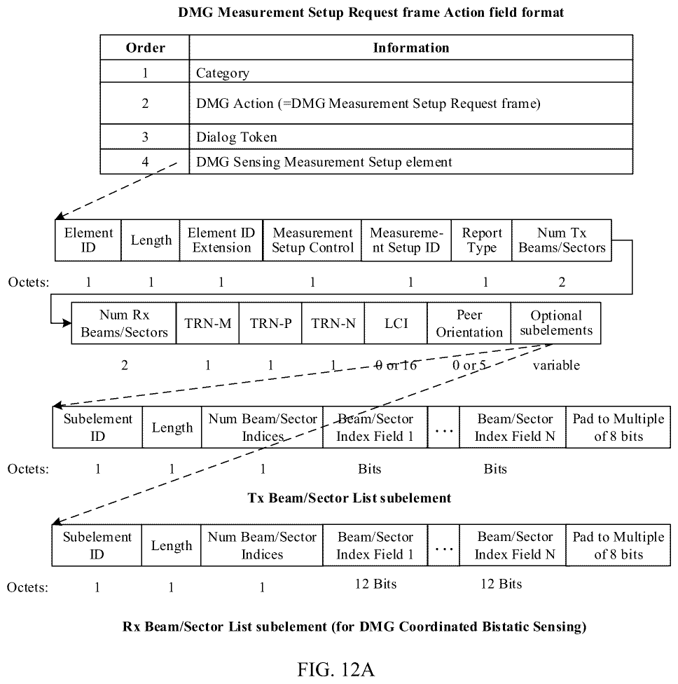

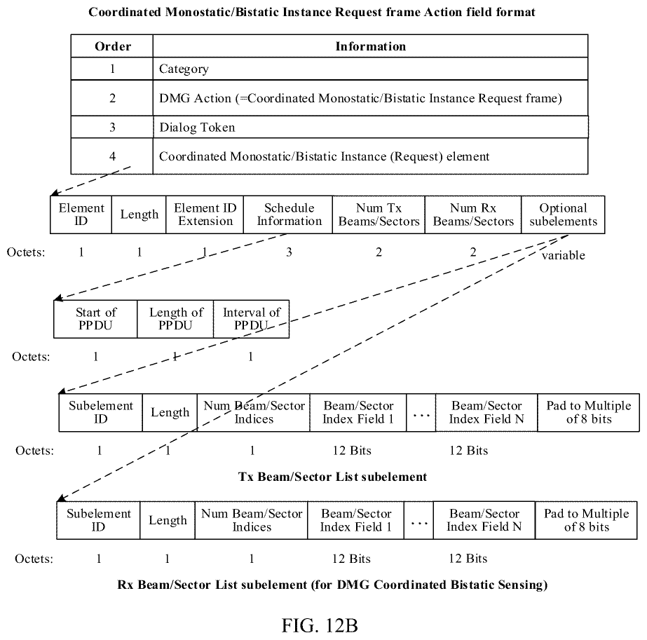

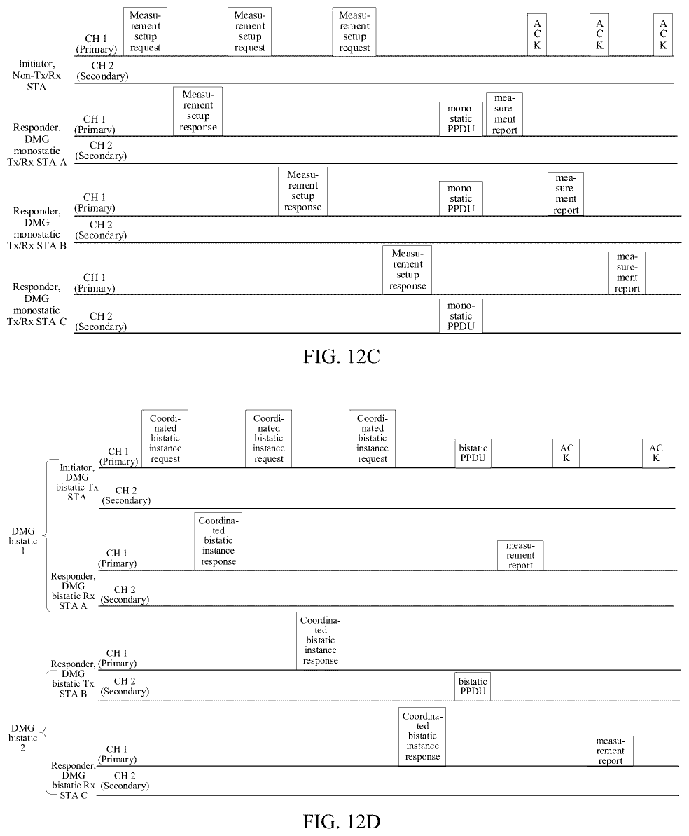

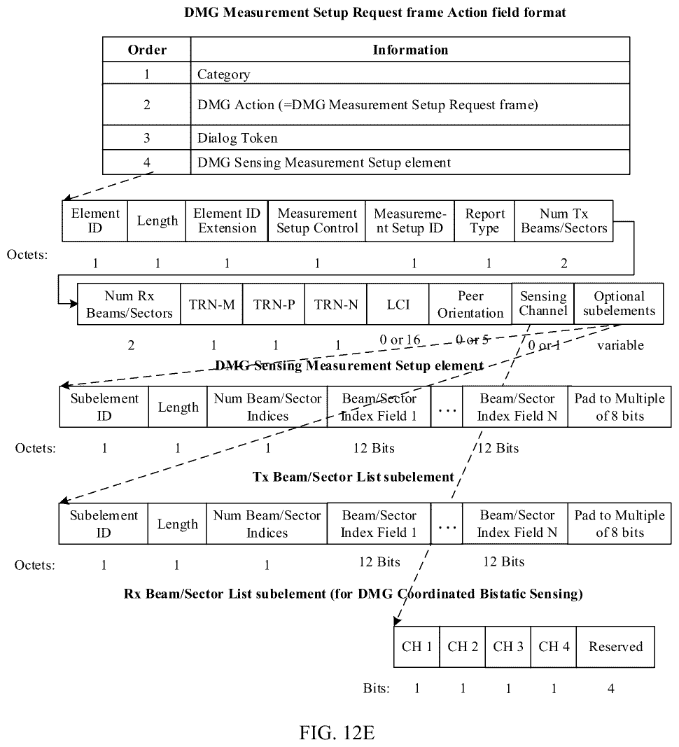

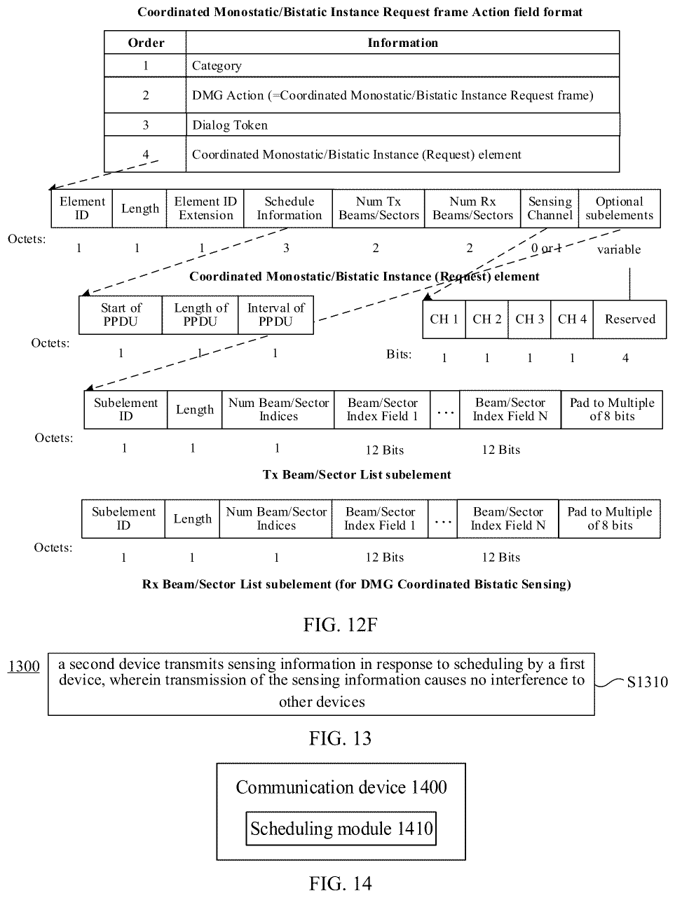

FIG. 12A is a schematic diagram of the format of a DMG measurement setup request frame. As shown in FIG. 12A, an action field of the DMG measurement setup request frame includes at least one of:

a category: indicating a category of the frame, wherein a value of the category of the DMG measurement setup request frame can be 16, representing the DMG action frame;

a DMG action: distinguishing different specific frames belonging to the category of the DMG action frame, wherein the DMG action field of the DMG measurement setup request frame can be set to any integer other than 0˜23;

a dialog token: matching an action response with an action request in the case that a plurality of concurrent action requests are present, wherein the dialog token field is set to a value selected by the STA of the transmitting frame to uniquely identify the interaction;

a DMG sensing measurement setup element: carrying specific DMG sensing setup information as follows:

a measurement setup control: indicating a command related to the sensing setup; for example, a category of sensing, e.g., indicating monostatic, bistatic, multi-static, coordinated monostatic, coordinated bistatic, or the like;

an LCI present: indicating whether an LCI field is present in the DMG measurement setup request frame; for example, a value of the LCI present being 1 indicates that the LCI field is present, and the value of the LCI present being 0 indicates that the LCI field is not present; alternatively, the value of the LCI present being 1 indicates that the LCI field is not present, and the value of the LCI present being 0 indicates that the LCI field is present;

an orientation present: indicating whether a peer direction is present in the DMG measurement setup request frame; for example, a value of the orientation present being 1 indicates the peer orientation is present, and the value of the orientation present being 0 indicates that the peer orientation is not present; alternatively, the value of the orientation present being 1 indicates that the peer orientation is not present, and the value of the orientation present being 0 indicates that the peer orientation is present;

a measurement setup ID: a value of this field being set by the initiator;

a report type: indicating what type of report the sensing initiator expects from the sensing responder;

number of Tx beams/sectors (Num Tx Beams/Sectors) and number of Rx beams/sectors (Num Rx Beams/Sectors): respectively indicating the number of beams/sectors in the Tx beam/sector list subelement and the number of beams/sectors in the Rx beam/sector list subelement; and

TRN-M, TRN-P, TRN-N: respectively indicating an EDMG-TRN-M, an EDMG-TRN-P, and an EDMG-TRN-N to be used for EDMG Bi-Static and EDMG Multi-Static sensing; and in the case that the addressed STA is not an EDMG STA, the TRN-M and the TRN-P are reserved and set to 0, wherein the TRN-N indicates the number of repetitions for each receiving mode;

an LCI: indicating the location information of the responder;

a peer orientation: indicating the direction and distance information of a peer responder measured by responder;

a Tx beam/sector list subelement: carried in the optional subelement field of the DMG sensing measurement setup element, wherein the Tx beam/sector list subelement is valid for both the DMG coordinated monostatic sensing mode and the DMG coordinated bistatic sensing mode, and includes:

number of beam/sector indices (Num Beam/Sector Indices): indicating the number of beams/sectors of the monostatic/bistatic sensing PPDUs transmitted by the responders;

beam/sector index fields 1 to N: indicating IDs of the beams/sectors of the monostatic/bistatic sensing PPDUs transmitted by the responders; and a padding (pad to multiple of 8 bits): causing a length of the whole Tx beam/sector list

subelement to be integer multiples of bytes (i.e., an integer multiple of 8 bits), because a length of the beam/sector index field is 12 bits, and an accumulation of the length of N beam/sector index fields may not be integer multiples of the number of bytes; and

an Rx beam/sector list subelement: carried in the optional subelement field of the DMG sensing measurement setup element, wherein the Rx beam/sector list subelement is valid only for DMG coordinated bistatic sensing mode, and includes:

Num Beam/Sector Indices: indicating the number of beams/sectors of the bistatic sensing PPDUs received by the responders;

beam/sector index fields 1 to N: indicating IDs of the beams/sectors of the bistatic sensing PPDUs received by the responders; and

a padding (pad to multiple of 8 bits): same as the related explanation of the transmit beam/sector list subelement.

It should be noted that upon the DMG sensing session setup and prior to the DMG measurement setup, the initiator does not know which responder(s) with DMG coordinated monostatic/bistatic sensing capability participates in the DMG sensing instance phase. Therefore, the initiator calculates the strength of interference caused by each transmitter's beam/sector to each receiver's beam/sector, based on an assumption that all responders with the DMG coordinated monostatic/bistatic sensing capability participate in the DMG sensing instance and transmit the monostatic/bistatic sensing PPDUs simultaneously. The initiator then assigns beams/sectors to the transmitters that do not cause (strong) interference to each other's receivers to transmit monostatic/bistatic sensing PPDUs, and assigns beams/sectors to the receivers that do not suffer from (strong) interference to receive the monostatic/bistatic sensing PPDUs (only for DMG coordinated bistatic sensing mode). Due to this scenario, the beams/sectors calculated by the initiator for transmitting and/or receiving monostatic/bistatic sensing PPDUs are not sufficiently accurate in the case that some responders do not participate in the DMG sensing instance phase (or the final number of beams/sectors assigned is less than an actual available number of beams/sector).

Assignment Method 2:

Initiator assigns beams not interfered to each other to the responders in the DMG sensing instance phase.

Referring to the scenario shown in FIG. 8, in the case that the initiator acquires beams/sectors causing no interference to each other between the initiator, the STA A, the STA B and the STA C by calculating upon DMG measurement setup and prior to DMG sensing instance,

with respect to the DMG coordinated monostatic sensing mode, the initiator can use the Tx beam/sector list subelement in the coordinated monostatic instance request frame to indicate which beams/sectors can be used by the STA A, the STA B, and the STA C to transmit the monostatic sensing PPDUs simultaneously without causing interference to each other;

with respect to the DMG coordinated bistatic sensing mode, the initiator can use the Tx beam/sector list subelement in the coordinated bistatic instance request frame to indicate which beams/sectors can be used by the STA B to transmit bistatic sensing PPDUs with the initiator simultaneously without causing interference to the reception of the STA A. In addition, the initiator can use the Rx beam/sector list subelement in the coordinated bistatic instance request frame to indicate which beams/sectors can be used by the STA A and the STA C to receive bistatic sensing PPDUs.

It should be noted that the methods that the initiator uses the Tx beam/sector list subelement in the measurement setup request frame to indicate which beams/sectors can be used by the responders to transmit monostatic/bistatic sensing PPDUs, and/or uses the Rx beam/sector list subelement to indicate which beams/sectors can be used by the responders to receive monostatic/bistatic sensing PPDUs, and the methods can also be applied to the scenario that initiator schedules the responders to sequentially transmit the monostatic/bistatic sensing PPDUs.

In some embodiments, the DMG measurement setup request frame indicating the beam/sector that causes no interference to the other devices includes the following scenario:

a coordinated monostatic/bistatic instance request frame indicates beams/sectors that cause no interference to the other devices, which includes the following scenario:

the coordinated monostatic/bistatic instance request frame include a coordinated monostatic/bistatic instance element, wherein the coordinated monostatic/bistatic instance element includes optional subelements, the optional subelements including at least one of the Tx beam/sector list subelement or the Rx beam/sector list subelement; wherein

the Tx beam/sector list subelement indicates the transmit beam/sector that causes no interference to the other devices; and

the Rx beam/sector list subelement indicates the receive beam/sector that suffers no interference from the other devices.

In some embodiments, the coordinated monostatic/bistatic instance element further includes a schedule information subelement, wherein the schedule information subelement includes at least one of:

a start of PPDU field, indicating a start time for the second device to transmit the monostatic/bistatic sensing PPDU;

a length of PPDU field, indicating a length of the monostatic/bistatic sensing PPDU transmitted by the second device; or

an interval of PPDU field, indicating a period for the second device to transmit the monostatic/bistatic sensing PPDU.

In some embodiments, the interval of PPDU field indicates a time interval between two adjacent sensing PPDUs in an instance; and/or the interval of PPDU field indicates a time for a next transmission of the sensing PPDU.

Because of the methods for assigning the beams/sectors causing no interference to each other in the above two phases, the Tx beam/sector list subelement and/or the Rx beam/sector list subelement may or may not be carried in the DMG measurement setup request frame.

In the case that the Tx beam/sector list subelement and/or the Rx beam/sector list subelement is not carried in the DMG measurement setup request frame, the Tx beam/sector list subelement and/or the Rx beam/sector list subelement can be carried by the coordinated monostatic/bistatic instance request frame, wherein the Tx beam/sector list subelement and/or the Rx beam/sector list subelement indicates the beam to be adopted by the responder.

In the case that the Tx beam/sector list subelement and/or the Rx beam/sector list subelement is carried in the DMG measurement setup request frame, the Tx beam/sector list subelement and/or the Rx beam/sector list subelement carried in the coordinated monostatic/bistatic instance request frame is optional. For example, in the case that the Tx beam/sector list subelement and/or the Rx beam/sector list subelement is carried in the coordinated monostatic/bistatic instance request frame, the Tx beam/sector list subelement and/or the Rx beam/sector list subelement can be configured to update the information in the Tx beam/sector list subelement and/or the Rx beam/sector list subelement carried by the DMG measurement setup request frame. In the case that the Tx beam/sector list subelement and/or the Rx beam/sector list subelement is not carried in the coordinated monostatic/bistatic instance request frame, the Tx beam/sector list subelement and/or the Rx beam/sector list subelement carried in the DMG measurement setup request frame indicates the beam to be adopted by the responder.

FIG. 12B is a schematic diagram of the format of a coordinated bistatic instance request frame. As shown in FIG. 12B, the action field of the coordinated bistatic instance request frame includes at least one of:

a category: indicating a category of the frame, wherein a value of the category of the coordinated monostatic/bistatic instance request frame can be 16, representing the DMG action frame;

a DMG action: distinguishing different frames belonging to the category of the DMG action frame, wherein the DMG action field of the coordinated monostatic/bistatic instance request frame can be set to any integer other than 0˜23, and it should be noted that the coordinated monostatic instance request frame and the coordinated bistatic instance request frame can use different DMG action values or the same DMG action value, but not equal to the DMG action value of the DMG measurement setup request frame;

a dialog token: matching an action response with an action request in the case that a plurality of concurrent action requests are present, wherein the dialog token field is set to a value selected by the STA of the transmitting frame to uniquely identify the interaction;

a coordinated monostatic/bistatic instance (request) element: carrying configuration information, wherein the configuration information includes:

schedule information: indicating the scheduling information of the coordinated monostatic/bistatic instance, including:

Num Tx Beams/Sectors: indicating the number of beams/sectors of the monostatic/bistatic sensing PPDUs transmitted by the sensing devices;

the start of PPDU: indicating the start time for the sensing device to transmit the monostatic/bistatic sensing PPDU;

the length of PPDU: indicating the length of the monostatic/bistatic sensing PPDU transmitted by the sensing device;

the interval of PPDU: indicating the period of the sensing device to transmit the monostatic/bistatic sensing PPDU; wherein in the case that a plurality of monostatic/bistatic sensing PPDUs can be transmitted by one instance, the interval of PPDU indicates the time interval between two monostatic/bistatic sensing PPDUs; in the case that only one monostatic/bistatic sensing PPDU can be transmitted by the instance, the interval of PPDU indicates the time for next transmission of the monostatic/bistatic sensing PPDU;

Num Tx Beams/Sectors: indicating the number of beams/sectors of the monostatic/bistatic sensing PPDUs transmitted by the sensing devices;

Num Rx Beam/Sectors: indicating the number of beams/sectors of the monostatic/bistatic sensing PPDUs received by the sensing devices; and

optional subelements: including the Tx beam/sector list subelement and/or the Rx beam/sector list subelement, whose details are consistent with those in the example shown in FIG. 12A and not repeated herein.

According to this example, because upon completing the DMG measurement setup, the initiator already knows which responder(s) participates in the DMG sensing instance phase, the initiator calculates the strength of interference caused by the Tx beam/sector of the transmitter to the Rx beam/sector of the receiver based on the responder that ultimately participates in the DMG sensing instance and transmits the monostatic/bistatic sensing PPDUs. The initiator then assigns Tx and/or Rx beams/sectors that cause no interference to each other to the responder to transmit the monostatic/bistatic sensing PPDUs. Unlike the previous assignment method, the last beam/sector assigned in the method is an actual available beam/sector.

Method 3: The initiator schedules the responders to transmit the sensing PPDUs on different channels.

This method can be applied to the scenario where the sensing devices are densely distributed and close to each other. In this scenario, the transmitting signals of the sensing devices may cause more interference to each other. In this case, the initiator (AP/STA) can schedule any two or more responders (with or without interference with each other) to transmit the monostatic/bistatic sensing PPDUs simultaneously or sequentially on different channels. Alternatively, the initiator can schedule any two or more responders to transmit the monostatic/bistatic sensing PPDUs simultaneously or sequentially on different channels, in the case that the transmitting signals of the sensing devices cause no interference to each other. In addition, the present method is not limited to scenarios in which the sensing devices are densely distributed and close to each other, but in other scenarios, different responders can also be scheduled to use different channels to transmit the sensing PPDUs.

In some embodiments, scheduling the second device to transmit the sensing information includes:

assigning a channel that causes no interference to the other devices (e.g., a channel that is different from channels used by the other devices) to the second device, and scheduling the second device to transmit the sensing information on the channel that causes no interference to the other devices.

For example, the first device schedules the second device and the other devices to transmit the sensing information simultaneously on different channels; or the first device schedules the second device and the other devices to transmit the sensing information sequentially on different channels.

Similar to Method 1 and 2, Method 3 also involves DMG coordinated monostatic sensing mode and DMG coordinated bistatic sensing mode.

In some embodiments, corresponding to the DMG coordinated monostatic sensing mode, the first device assigns different channels to the plurality of second devices and schedules the plurality of second devices to transmit sensing PPDUs on the assigned channels.

In some embodiments, corresponding to the DMG coordinated bistatic sensing mode, the first device assigns channels that are different from the channels used by the other devices (including the second device and the first device) to the one or more second devices, and schedules the one or more second devices to transmit the sensing PPDUs on the assigned channels.

With respect to the assignment of channels, the embodiments of the present disclosure perform channel assignment in at least two phases, i.e., the DMG measurement setup phase and the DMG sensing instance phase.

For example, the first device transmits the DMG measurement setup request frame to the second device, wherein the DMG measurement setup request frame indicates a channel that causes no interference to the other devices; and/or

the first device transmits the coordinated monostatic/bistatic instance request frame to the second device, wherein the coordinated monostatic/bistatic instance request frame indicates a channel that causes no interference to the other devices.

In the case that the first device performs channel assignment in both of the preceding phases, i.e., the first device transmits the DMG measurement setup request frame and the coordinated monostatic/bistatic instance request frame to the second device, the information indicated by the coordinated monostatic/bistatic instance request frame is configured to update the information indicated by the DMG measurement setup request frame.

The following describes the channel assignment methods for different scenarios.

1. The DMG coordinated monostatic sensing scenario:

Referring to the scenario shown in FIG. 8, the initiator (non-Tx/Rx STA, which may be an AP) requests location and/or beam direction information of the STA A, the STA B and the STA C sequentially over the information request frame, and then calculates the strength of interference caused by any beams/sectors of any two STAs of the STA A, the STA B, and the STA C by using the method described in the previous embodiments.

In the case that the calculated strength of interference (I) between two STAs (e.g., the STA A and the STA C, or the STA B and the STA C) on the primary channel (e.g., CH 1) is greater than the threshold (γ), the two STAs are scheduled to transmit the monostatic sensing PPDUs simultaneously on different channels (e.g., one in CH 1 and the other in CH 2), or the two STAs are scheduled to transmit the monostatic sensing PPDUs sequentially on different channels. In some embodiments, the above strength of interference (I) greater than the threshold (γ) refers to the strength of interference (I) caused by at least one transmit beam/sector of one device to the receive beam/sector of the other device being greater than the threshold (γ).

In the case that the strength of interference (I) between two STAs (e.g., the STA A and the STA B) on the primary channel (e.g., CH 1) is calculated to be less than the threshold (γ), the two STAs are scheduled to transmit the monostatic sensing PPDUs on the same channel (e.g., the primary channel CH 1) or different channels simultaneously, or the two STAs are scheduled to transmit the monostatic sensing PPDUs on the same channel (e.g., the primary channel CH 1) or different channels sequentially. In some embodiments, the above strength of interference (I) less than the threshold (γ) refers to the strength of interference (I) caused by each of all transmit beams/sectors of one device to the receive beams/sectors of the other devices being less than the threshold (γ).

FIG. 12C is a schematic diagram of an initiator scheduling STAs interfered with each other to transmit the monostatic sensing PPDUs on different channels simultaneously. In the example that in the DMG coordinated monostatic sensing scenario, the STA A and the STA B cause no interference to each other on the primary channel (CH) (CH 1), the STA A and the STA C cause interference to each other on the primary channel (CH 1), and the STA B and the STA C cause interference to each other on the primary channel (CH 1), FIG. 12C illustrates the signaling process that the initiator schedules the STA A and the STA B on the primary channel (CH 1) and the STA C on the secondary channel (CH 2) to transmit the monostatic sensing PPDUs simultaneously. The initiator can schedule the STA A and the STA B on the primary channel (CH 1) and the STA Con the secondary channel (CH 2) to transmit the monostatic sensing PPDUs sequentially.

2. The DMG coordinated bistatic sensing scenario:

Referring to the scenario shown in FIG. 8, the initiator (non-Tx/Rx STA, which may be an AP) sequentially requests location and/or beam direction information of the STA A, the STA B, and the STA C over the information request frame, and then calculates the strength of interference caused by any beams/sectors of any two STAs of the STA A, the STA B, and the STA C by using the method described in the previous embodiments.

In the case that the calculated strength of interference (I) caused by the transmitter (e.g., the initiator) of a bistatic (e.g., the initiator and the STA A) to the receiver (e.g., the STA C) of another bistatic (e.g., the STA B and the STA C) on the primary channel (CH 1) is greater than the threshold (γ), then the STA B is scheduled to transmit the bistatic sensing PPDUs on the different channels with the initiator simultaneously, or the STA B is scheduled to transmit bistatic sensing PPDUs on different channels at different times with the initiator.

In the case that the calculated strength of interference (I) caused by the transmitter (e.g., the initiator) of a bistatic (e.g., the initiator and the STA A) to the receiver (e.g., the STA C) of another bistatic (e.g., the STA B and the STA C) on the primary channel (CH 1) is less than the threshold (Y), and the strength of interference (I) caused by the transmitter (e.g., the STA B) of a certain bistatic (e.g., the STA B and the STA C) to the receiver (e.g., the STA A) of another bistatic (e.g., the initiator and the STA A) is also less than the threshold (y), then the STA (i.e., the STA B) is scheduled to transmit the bistatic sensing PPDUs on the same channel (e.g., the primary channel CH 1) or on different channels with the initiator simultaneously, or the STA (i.e., the STA B) is scheduled to transmit the bistatic sensing PPDUs on the same channel (e.g., the primary channel CH 1) or on different channels with the initiator sequentially.

FIG. 12D is a schematic diagram of an initiator scheduling a STA B interfered with each other to transmit the bistatic sensing PPDUs simultaneously on different channels. In the example that the initiator and the STA B cause interference to each other's receivers in the DMG coordinated monostatic sensing scenario, FIG. 12D illustrates the signaling process that the initiator schedules the STA B to use a channel (CH) (e.g., secondary channel CH 2) different from the channel (e.g., primary channel CH 1) used by the initiator, and to transmit the monostatic sensing PPDUs simultaneously with the initiator. The initiator can also schedule the STA B to use a secondary channel (CH 2) and transmit the monostatic sensing PPDUs at a different time with the initiator. In some embodiments, the DMG measurement setup request frame is configured to assign

channels. FIG. 12E is a schematic diagram of a format of a DMG measurement setup request frame according to some embodiments of the present disclosure. As shown in FIG. 12E, a sensing channel field is added to the DMG measurement setup request frame in the embodiments of present disclosure, wherein the sensing channel field indicates a channel assigned to the sensing responder receiving the frame to transmit the sensing PPDU.

Because 802.11ad/ay supports four 2.16 GHz channels, the sensing channel field can use four bits to indicate four channels (e.g., CH1, CH2, CH3, and CH4). For example, in the case that an indicator bit corresponding to a channel is set to 1, the channel is configured to transmit the sensing PPDUs. In the case that the indicator bit corresponding to the channel is set to 0, the channel is configured to not transmit the sensing PPDUs. Alternatively, in the case that the indicator bit corresponding to the channel is set to 0, the channel is configured to transmit the sensing PPDUs. In the case that the indicator bit corresponding to the channel is set to 1, the channel is configured to not transmit the sensing PPDUs.

Alternatively, the sensing channel field can be realized by using two bits to indicate four channels. The two bits are taken as 00, 01, 10 and 11 corresponding to the four 2.16 GHz channels. For example, sensing channel field=00 indicates that the 1st 2.16 GHz channel is configured to transmit the sensing PPDU, and so on thereafter.

Other portions of the DMG measurement setup request frame shown in FIG. 12E are referred to the existing format and contents shown in the FIG. 12A, and not repeated herein.

In some embodiments, the coordinated monostatic/bistatic instance request frame is configured to assign channels. FIG. 12F is a schematic diagram of a format of a coordinated monostatic/bistatic instance request frame according to some embodiments of the present disclosure. As shown in FIG. 12F, a sensing channel field is added to the coordinated monostatic/bistatic instance request frame in the embodiments of the present disclosure, wherein the sensing channel field indicates a channel assigned to the sensing responder receiving the frame to transmit the sensing PPDU.

The method for indicating the channel by the sensing channel field in the coordinated monostatic/bistatic instance request frame can be referred to the method for indicating the channel by the sensing channel field in the DMG measurement setup request frame in the above embodiments, and the contents of the other portions of the coordinated monostatic/bistatic instance request frame can be referred to the existing format and the contents shown in the above FIG. 12B, which are not repeated herein.

It should also be emphasized that in the DMG coordinated monostatic and bistatic sensing scheme, the lengths, the parameter configurations, and the like of the monostatic/bistatic sensing PPDUs transmitted by a plurality of sensing devices simultaneously needs to be consistent, which requires that the sensing devices transmitting monostatic/bistatic sensing PPDUs to use the same number of transmit beams/sectors, and the configuration information of the TRN (e.g., TRN-M, TRN-N, TRN-P, and the like) need to be consistent.

Based on the above contents, it can be seen that the embodiments of the present disclosure provide three different DMG coordinated monostatic/bistatic sensing scheduling strategies, which can avoid causing interference to each other's receivers when a plurality of transmitters transmit monostatic/bistatic sensing PPDUs simultaneously, thereby making the DMG coordinated monostatic/bistatic sensing results more accurate.

Furthermore, in the case that the initiator calculates the beam/sector not interfering with each other of each responder that transmits the monostatic/bistatic sensing PPDUs simultaneously, these beam/sector information can be informed to each responder in the DMG measurement setup phase, or these beam/sector information can be informed to each responder in the initiation phase of the DMG sensing instance, wherein the beam/sector information enables the responder to have a larger number of available beams/sectors, and the result of beam/sector assignment is more accurate.

Some embodiments of the present disclosure also provide a communication method. FIG. 13 is a schematic flowchart of a communication method 1300 according to some embodiments of the present disclosure. The method can be applied to the system shown in FIG. 1, but is not limited thereto. The method includes at least part of the following contents.

In S1310, a second device transmits sensing information in response to scheduling by a first device, wherein transmission of the sensing information causes no interference to other devices.

The first device is a sensing initiator, and the second device is a sensing responder. The sensing information is a sensing PPDU.

In some embodiments, the second device is a second device that causes no interference to the other devices.

This method can be applicable to a scenario in which the sensing devices are sparsely distributed and distant from each other. In this scenario, the transmitting signals of the sensing devices generally cause no interference to each other, and the initiator (AP/STA) schedules these devices that cause no interference to each other to transmit sensing PPDUs simultaneously.

In some embodiments, transmitting sensing information in response to the scheduling by the first device includes: transmitting the sensing information on a beam/sector/channel assigned by the first device, wherein the beam/sector/channel causes no interference to the other devices.

This method can be applied to the scenario where the sensing devices are densely distributed and closer to each other. In this scenario, the transmitting signals of the sensing devices cause greater interference to each other, and the initiator (AP/STA) can schedule any two or more responders (with or without interference with each other) to transmit the monostatic/bistatic sensing PPDUs simultaneously on beams/sectors that cause no interference to each other.

In some embodiments, the method further includes:

receiving, by the second device, a DMG measurement setup request frame from the first device, wherein the DMG measurement setup request frame indicates the beam/sector/channel that causes no interference to the other devices; and/or

receiving, by the second device, a coordinated monostatic/bistatic instance request frame from the first device, wherein the coordinated monostatic/bistatic instance request frame indicates the beam/sector/channel that causes no interference to the other devices.

By receiving the DMG measurement setup request frame and/or the coordinated monostatic/bistatic instance request frame from the first device, the second device can acquire the beam/sector/channel assigned by the first device and sense PPDU transmission and/or reception in the subsequent sensing measurement process on the beam/sector/channel.

In the case that the second device receives the DMG measurement setup request frame and the coordinated monostatic/bistatic instance request frame from the first device, the second device can update the information indicated by the DMG measurement setup request frame by using the information indicated by the monostatic/bistatic instance request frame.

In some embodiments, the DMG measurement setup request frame includes a DMG sensing measurement setup element, wherein the DMG sensing measurement setup element includes an optional subelement, the optional subelement including at least one of a Tx beam/sector list subelement or a Rx beam/sector list subelement; wherein

the Tx beam/sector list subelement indicates a transmit beam/sector that causes no interference to the other devices; and

the Rx beam/sector list subelement indicates a receive beam/sector that suffers no interference from the other devices.

In some embodiments, the DMG measurement setup request frame indicating the channel that causes no interference to the other devices includes the following scenario:

the DMG measurement setup request frame includes a DMG sensing measurement setup element, wherein the DMG sense measurement setup element includes a sensing channel field, the sensing channel field indicating the channel that causes no interference to the other devices.

In some embodiments, the coordinated monostatic/bistatic instance request frame includes a coordinated monostatic/bistatic instance element, wherein the coordinated monostatic/bistatic instance element includes an optional subelement, the optional subelement including at least one of a transmit beam/sector list subelement or a receive beam/sector list subelement; wherein

the coordinated monostatic/bistatic instance request frame indicating the beam/sector that causes no interference to the other devices includes the following scenario:

the coordinated monostatic/bistatic instance request frame includes a coordinated monostatic/bistatic instance element, wherein the coordinated monostatic/bistatic instance element includes a sensing channel field, the sensing channel field indicating the channel that causes no interference to the other devices.

The subelement indicates the transmit beam/sector that causes no interference to the other devices.

The receive beam/sector list subelement indicates the receive beam/sector that suffers no interference from the other devices.

In some embodiments, the coordinated monostatic/bistatic instance element further includes a schedule information subelement, wherein the schedule information subelement includes at least one of:

a start of PPDU field, indicating a start time for the second device to transmit a monostatic/bistatic sensing PPDU;

a length of PPDU field, indicating a length of the monostatic/bistatic sensing PPDU transmitted by the second device; or

an interval of PPDU field, indicating a period for the second device to transmit the monostatic/bistatic sensing PPDU.

For example, the interval of PPDU field indicates a time interval between two adjacent sensing PPDUs in an instance; and/or the interval of PPDU field indicates a time for a next transmission of the sensing PPDU.

In some embodiments, in the case that the first device assigns the beam/sector/channel to each of the second devices, the lengths of the monostatic/bistatic sensing PPDUs indicated by the length of PPDU fields are equal.

In some embodiments, each of the second devices is assigned equal number of the beams/sectors by the first device; and/or

each of the second devices is assigned same training (TRN) configuration information by the first device.

In some embodiments, the communication method 1300 provided by the embodiments of the present disclosure further includes:

receiving, by the second device, a request message from the first device; and

transmitting, by the second device, at least one of location, beam information, or sector information of the second device to the first device.

Based on the above process, the second device reports its location and/or beam (or sector) information to the first device.

In some embodiments, receiving the request message from the first device includes:

receiving an information request frame or a probe request frame from the first device;

wherein the information request frame or the probe request frame carries a first identifier and/or a second identifier, the first identifier being an identifier for requesting to acquire a first relevant information element of the second device, and the second identifier being an identifier for requesting to acquire a second relevant information element of the second device.

For example, the information request frame or the probe request frame includes a request element or an extended request element, wherein the request element or the extended request element carries the first identifier and/or the second identifier.

In some embodiments, transmitting at least one of the location, the beam information, or the sector information of the second device to the first device includes:

transmitting an information response frame or a probe response frame to the first device;

wherein the information response frame or the probe response frame includes a sensing beam element and a sensing beam description element, wherein the sensing beam element carries the first identifier and further carries the number of beams for sensing configured by the second device and/or location information of the second device, and the sensing beam description element carries the second identifier and beam information of each of the beams of the second device.

In some embodiments, the information response frame or the probe response frame including the sensing beam element and the sensing beam description element includes the following scenario:

the information response frame or the probe response frame includes a requested element, wherein the requested element includes the sensing beam clement and the sensing beam description element.

In some embodiments, the above sensing beam element includes at least one of:

an element ID field;

an clement length field;

an element ID extension field, configured to carry the first identifier;

a number of beams field, configured to carry the number of beams for sensing configured by the second element;

an information control field; or

an LCI field, configured to carry the location information of the second device.

In some embodiments, the sensing beam description element includes at least one of:

an element ID field;

an element length field;

an element ID extension field, configured to carry the second identifier;

a transmit indication field, configured to indicate beam information of a transmit beam or a receive beam carried by the sensing beam description element;

a start beam index field, configured to indicate an identifier of a 1st beam carried by the sensing beam description element;

a beam index step field, configured to indicate a step between beam IDs carried by the sensing beam description element; or

a plurality of first beam descriptors, wherein each of the plurality of first beam descriptors carries beam information of one beam.

In some embodiments, the sensing beam description element includes at least one of: an element ID field;

an element length field;

an element ID extension field, configured to carry the second identifier;

a transmit indication field, configured to indicate beam information of a transmit beam or a receive beam carried by the sensing beam description element; or

a plurality of second beam descriptors, wherein each of the plurality of second beam descriptors carries beam information of one beam and an identifier of the beam.

In some embodiments, receiving the request message from the first device includes:

receiving an information request frame or a probe request frame from the first device;

wherein the information request frame or the probe request frame carries a third identifier and/or a fourth identifier, wherein the third identifier is an identifier for requesting to acquire a third relevant information element of the second device, and the fourth identifier is an identifier for requesting to acquire a fourth relevant information element of the second device.

For example, the information request frame or the probe request frame includes a request element or an extended request element, wherein the request element or the extended request element carries the third identifier and/or the fourth identifier.

Accordingly, in some embodiments, transmitting at least one of the location, the beam information, or the sector information of the second device to the first device includes:

transmitting an information response frame or a probe response frame to the first device;

wherein the information response frame or the probe response frame includes a sensing sector element and a sensing sector description element, wherein the sensing sector element carries the third identifier and further carries the number of sectors for sensing configured by the second device and/or location information of the second device, and the sensing sector description element carries the fourth identifier and beam information of each of the sectors of the second device.

For example, the information response frame or the probe response frame includes a requested element, wherein the requested element includes the sensing sector element and the sensing sector description element.

In some embodiments, the sensing sector element includes at least one of:

an element ID field;

an element length field;

an element ID extension field, configured to carry the third identifier;

a number of beams field, configured to carry the number of sectors for sensing configured by the second element;

an information control field; or

an LCI field, configured to carry the location information of the second device.

In some embodiments, the sensing sector description element includes at least one of:

an element ID field;

an element length field;

an element ID extension field, configured to carry the fourth identifier;

a transmit indication field, configured to indicate sector information of a transmit sector or a receive sector carried by the sensing sector description element;

a start sector index field, configured to indicate an identifier of a 1st sector carried by the sense sector description element;

a sector index step field, configured to indicate a step between sector IDs carried by the sensing sector description element; or

a plurality of first sector descriptors, wherein each of the plurality of first sector descriptors carries sector information and a DMG antenna ID of a sector.

In some embodiments, the sensing sector description element includes at least one of:

an element ID field;

an element length field;

an element ID extension field, configured to carry the fourth identifier;

a transmit indication field, configured to indicate sector information of a transmit sector or

a receive sector carried by the sensing sector description element; or

a plurality of second sector descriptors, wherein each of the plurality of second sector descriptors carries sector information, a DMG antenna ID and an identifier of one sector.

According to the embodiments of the present disclosure, the first device schedules the second device to transmit the sensing information to avoid interference caused by transmission of the sensing information.

Embodiments of the present disclosure also provide a communication device, FIG. 14 is a schematic structural diagram of a communication device 1400 according to some embodiments of the present disclosure. The device includes:

a scheduling module 1410, configured to schedule a second device to transmit sensing information, wherein transmission of the sensing information causes no interference to other devices.

In some embodiments, the communication device is the first device described above, e.g., the initiator, the second device is the responder, and the sensing information is a sensing PPDU.

In some embodiments, the scheduling module 1410 is configured to schedule the second device that causes no interference to the other devices to transmit the sensing information.

For example, the scheduling module 1410 schedules a plurality of second devices to transmit the sensing information, wherein any one of the plurality of second devices causes no interference to the other second devices.

For another example, the scheduling module 1410 schedules one or more second devices to transmit the sensing information, wherein any one of the one or more second devices causes no interference to the first device and/or other second devices.

In some embodiments, the scheduling module 1410 is configured to schedule the second device that causes no interference to the other devices and the other devices to transmit the sensing information simultaneously, or schedule the second device that causes no interference to the other devices and the other devices to transmit the sensing information sequentially.

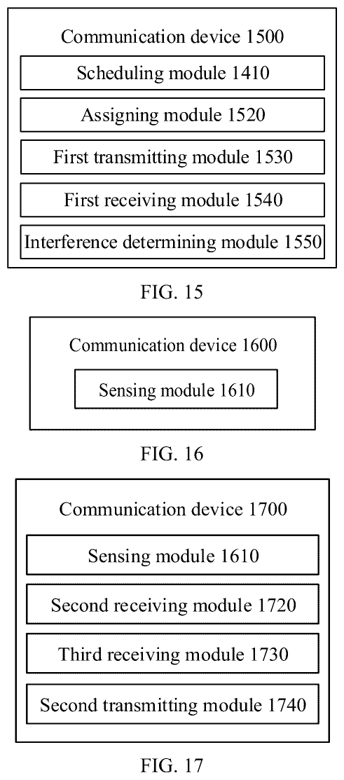

FIG. 15 is a schematic structural diagram of a communication device 1500 according to some embodiments of the present disclosure. As shown in FIG. 15, in some embodiments, the device further includes:

an assigning module 1520, configured to assign a beam/sector/channel that causes no interference to the other devices to the second device.

In some embodiments, the assigning module 1520 is configured to assign a transmit beam/sector/channel that causes no interference to the other second devices to each of a plurality of second devices, and/or assign a receive beam/sector/channel that suffers no interference from the other second devices to each of the plurality of second devices.

For example, the assigning module 1520 is configured to assign a transmit beam/sector/channel that causes no interference to the first device and/or the other second devices to each of one or more second devices, and/or assign a receive beam/sector/channel that suffers no interference from the first device and/or the other second devices to each of the one or more second devices.

In some embodiments, the scheduling module 1410 is configured to schedule the second device and the other devices to transmit the sensing information simultaneously; or schedule the second device and the other devices to transmit the sensing information sequentially; wherein the second device performs transmitting on the beam/sector/channel that causes no interference to the other devices.

In some embodiments, the assigning module 1520 is configured to transmit the DMG measurement setup request frame to the second device, wherein the DMG measurement setup request frame indicates the beam/sector/channel that causes no interference to the other devices; and/or transmit the coordinated monostatic/bistatic instance request frame to the second device, wherein the coordinated monostatic/bistatic instance request frame indicates the beam/sector/channel that causes no interference to the other devices.

In some embodiments, in the case that the first device transmits the DMG measurement setup request frame and the coordinated monostatic/bistatic instance request frame to the second device, information indicated by the coordinated monostatic/bistatic instance request frame is configured to update information indicated by the DMG measurement setup request frame.

In some embodiments, the DMG measurement setup request frame indicating the beam/sector that causes no interference to the other devices includes the following scenario:

the DMG measurement setup request frame includes a DMG sensing measurement setup element, wherein the DMG sensing measurement setup element includes an optional subelement, the optional subelement including at least one of a transmit beam/sector list subelement or a receive beam/sector list subelement; wherein

the transmit beam/sector list subelement indicates a transmit beam/sector that causes no interference to the other devices; and

the receive beam/sector list subelement indicates a receive beam/sector that suffers no interference from the other devices.

In some embodiments, the DMG measurement setup request frame indicating the channel that causes no interference to the other devices includes the following scenario:

the DMG measurement setup request frame includes a DMG sensing measurement setup clement, wherein the DMG sense measurement setup element includes a sensing channel field, the sensing channel field indicating the channel that causes no interference to the other devices.

In some embodiments, the coordinated monostatic/bistatic instance request frame indicating the beam/sector that causes no interference to the other devices includes the following scenario:

the coordinated monostatic/bistatic instance request frame includes a coordinated monostatic/bistatic instance element, wherein the coordinated monostatic/bistatic instance element includes an optional subelement, the optional subelement including at least one of a transmit beam/sector list subelement or a receive beam/sector list subelement; wherein

the transmit beam/sector list subelement indicates a transmit beam/sector that causes no interference to the other devices; and

the receive beam/sector list subelement indicates a receive beam/sector that suffers no interference from the other devices.

In some embodiments, the coordinated monostatic/bistatic instance request frame indicating the channel that causes no interference to the other devices includes the following scenario:

the coordinated monostatic/bistatic instance request frame includes a coordinated monostatic/bistatic instance element, wherein the coordinated monostatic/bistatic instance element includes a sensing channel field, the sensing channel field indicating the channel that causes no interference to the other devices.

In some embodiments, the coordinated monostatic/bistatic instance element further includes a schedule information subelement, wherein the schedule information subelement includes at least one of:

a start of PPDU field, indicating a start time for the second device to transmit a monostatic/bistatic sensing PPDU;

a length of PPDU field, indicating a length of the monostatic/bistatic sensing PPDU transmitted by the second device; or

an interval of PPDU field, indicating a period for the second device to transmit the monostatic/bistatic sensing PPDU.

In some embodiments, the interval of PPDU field indicates a time interval between two adjacent sensing PPDUs in an instance; and/or the interval of PPDU field indicates a time for a next transmission of the sensing PPDU.

In some embodiments, in the case that the assigning module 1520 assigns the beam/sector/channel to each of the plurality of second devices, the lengths of the monostatic/bistatic sensing PPDUs indicated by the length of PPDU fields are equal.

In some embodiments, numbers of the beams/sectors assigned by the first device to each of the plurality of second devices are equal; and/or TRN configuration information assigned by the first device to each of the plurality of second devices are the same.

As shown in FIG. 15, the communication device further includes:

a first transmitting module 1530, configured to transmit a request message to each of a plurality of second devices;

a first receiving module 1540, configured to receive at least one of location, beam information, or sector information of the plurality of second devices from the second devices.

As shown in FIG. 15, the communication device further includes:

an interference determining module 1550, configured to determine, based on at least one of the location, the beam information, or the sector information of the second device, a strength of interference caused by a transmit beam/sector of each of the plurality of second devices to receive beams/sectors of the other devices; and

determine that the transmit beam/sector of the second device causes no interference to the other devices in the case that the strength of interference caused by the transmit beam/sector of the second device to the receive beams/sectors of the other devices is less than or equal to a first threshold; or determine that the second device causes no interference to the other devices in the case that the strength of interference caused by the transmit beam/sector of each of the plurality of second devices to the receive beams/sectors of the other devices is less than or equal to the first threshold.

In some embodiments, the first transmitting module 1530 is configured to transmit an information request frame or a probe request frame to each of the plurality of second devices;

wherein the information request frame or the probe request frame carries a first identifier and/or a second identifier, wherein the first identifier is an identifier for requesting to acquire a first relevant information element of the second device, and the second identifier is an identifier for requesting to acquire a second relevant information element of the second device.

For example, the information request frame or the probe request frame includes a request element or an extended request element, wherein the request element or the extended request element carries the first identifier and/or the second identifier.

In some embodiments, the first receiving module 1540 is configured to receive an information response frame or a probe response frame from each of the plurality of second devices;

wherein the information response frame or the probe response frame includes a sensing beam element and a sensing beam description element, wherein the sensing beam element carries the first identifier and further carries the number of beams for sensing configured by the second device and/or location information of the second device, and the sensing beam description element carries the second identifier and beam information of each of the beams of the second device.

For example, the information response frame or the probe response frame includes a requested element, wherein the requested element includes the sensing beam element and the sensing beam description element.

In some embodiments, the sensing beam element includes at least one of:

an element ID field;

an element length field;

an element ID extension field, configured to carry the first identifier;

a number of beams field, configured to carry the number of beams for sensing configured by the second element;

an information control field; or

an LCI field, configured to carry the location information of the second device.

In some embodiments, the sensing beam description element includes at least one of:

an element ID field;

an element length field;

an element ID extension field, configured to carry the second identifier;

a transmit indication field, configured to indicate beam information of a transmit beam or

a receive beam carried by the sensing beam description element;

a start beam index field, configured to indicate an identifier of a 1st beam carried by the sensing beam description element;

a beam index step field, configured to indicate a step between beam IDs carried by the

sensing beam description element; or

a plurality of first beam descriptors, wherein each of the plurality of first beam descriptors carries beam information of one beam.

In some embodiments, the sensing beam description element includes at least one of:

an element ID field;

an element length field;

an element ID extension field, configured to carry the second identifier;

a transmit indication field, configured to indicate beam information of a transmit beam or a receive beam carried by the sensing beam description element; or

a plurality of second beam descriptors, wherein each of the plurality of second beam descriptors carries beam information of one beam and an identifier of the beam.

In some embodiments, the first transmitting module 1530 is configured to transmit an information request frame or a probe request frame to each of the plurality of second devices;

wherein the information request frame or the probe request frame carries a third identifier and/or a fourth identifier, wherein the third identifier is an identifier for requesting to acquire a third relevant information element of the second device, and the fourth identifier is an identifier for requesting to acquire a fourth relevant information element of the second device.

For example, the information request frame or the probe request frame includes a request element or an extended request element, wherein the request element or the extended request element carries the third identifier and/or the fourth identifier.

In some embodiments, the first receiving module 1540 is configured to receive an information response frame or a probe response frame from each of the plurality of second devices;

wherein the information response frame or the probe response frame includes a sensing sector element and a sensing sector description element, wherein the sensing sector element carries the third identifier and further carries the number of sectors for sensing configured by the second device and/or location information of the second device, and the sensing sector description element carries the fourth identifier and beam information of each of the sectors of the second device.

For example, the information response frame or the probe response frame includes a requested element, wherein the requested element includes the sensing sector element and the sensing sector description element.

In some embodiments, the sensing sector element includes at least one of:

an element ID field;

an element length field;

an element ID extension field, configured to carry the third identifier;

a number of beams field, configured to carry the number of sectors for sensing configured by the second element;

an information control field; or

an LCI field, configured to carry the location information of the second device.

In some embodiments, the sensing sector description element includes at least one of:

an element ID field;

an element length field;

an element ID extension field, configured to carry the fourth identifier;

a transmit indication field, configured to indicate sector information of a transmit sector or a receive sector carried by the sensing sector description element;

a start sector index field, configured to indicate an identifier of a 1st sector carried by the sense sector description element;

a sector index step field, configured to indicate a step between sector IDs carried by the sensing sector description element; or

a plurality of first sector descriptors, wherein each of the plurality of first sector descriptors carries sector information and a DMG antenna ID of a sector.

In some embodiments, the sensing sector description element includes at least one of the following:

an element ID field;

an element length field;

an element ID extension field, configured to carry the fourth identifier;

a transmit indication field, configured to indicate sector information of a transmit sector or a receive sector carried by the sensing sector description element; or

a plurality of second sector descriptors, wherein each of the plurality of second sector descriptors carries sector information, a DMG antenna ID and an identifier of one sector.

In some embodiments, the interference determining module 1550 is configured to determine the strength of interference caused by the transmit beam/sector of each of the plurality of second devices to the receive beams/sectors of the other devices based on at least one of:

a transmit power of the second device;

a transmit gain of the transmit beam/sector of the second device;

a receive gain of the receive beam/sector of the other device;

angle information of the transmit beam/sector of the second device;

angle information of the receive beam/sector of the other device; or

a path loss of a signal from the second device to the other device, wherein the path loss is related to a location of the second device and a location of the other device.

In some embodiments, the angle information includes at least one of an elevation, an azimuth, an elevation beamwidth, or an azimuth beamwidth.

It is understandable that the above and other operations and/or functions of the modules in the communication device according to some embodiments of the present disclosure are intended to realize the corresponding processes of the first device in the method 200 shown in FIG. 2, which are not repeated herein for brevity.

Embodiments of the present disclosure also provide a communication device. FIG. 16 is a schematic structural diagram of the communication device 1600 according to some embodiments of the present disclosure. The device includes:

a sensing module 1610, configured to transmit sensing information in response to scheduling by a first device, wherein transmission of the sensing information causes no interference to the other devices.

In some embodiments, the communication device is the second device described above, e.g., a responder, the first device is an initiator, and the sensing information is a sensing PPDU.

In some embodiments, the second device is a second device that causes no interference to the other devices.

In some embodiments, the sensing module 1610 transmits the sensing information on a beam/sector/channel assigned by the first device, wherein the beam/sector/channel causes no interference to the other devices.

FIG. 17 is a schematic structural diagram of a communication device 1700 according to some embodiments of the present disclosure. As shown in FIG. 17, in some embodiments, the device further includes:

a second receiving module 1720, configured to receive a DMG measurement setup request frame from the first device, wherein the DMG measurement setup request frame indicates the beam/sector/channel that causes no interference to the other devices; and/or receive a coordinated monostatic/bistatic instance request frame from the first device, wherein the coordinated monostatic/bistatic instance request frame indicates the beam/sector/channel that causes no interference to the other devices.

In some embodiments, in the case that the second device receives the DMG measurement setup request frame and the coordinated monostatic/bistatic instance request frame from the first device, the second device updates information indicated by the DMG measurement setup request frame by using information indicated by the monostatic/bistatic instance request frame.

In some embodiments, the DMG measurement setup request frame indicating the beam/sector/channel that causes no interference to the other devices includes the following scenario:

the DMG measurement setup request frame includes a DMG sensing measurement setup element, wherein the DMG sensing measurement setup element includes an optional subelement, the optional subelement including at least one of a transmit beam/sector list subelement or a receive beam/sector list subelement; wherein

the transmit beam/sector list subelement indicates a transmit beam/sector that causes no interference to the other devices; and

the receive beam/sector list subelement indicates a receive beam/sector that suffers no interference from the other devices.

In some embodiments, the DMG measurement setup request frame indicating the channel that causes no interference to the other devices includes the following scenario:

the DMG measurement setup request frame includes a DMG sensing measurement setup element, wherein the DMG sensing measurement setup element includes a sensing channel field, the sensing channel field indicating the channel that causes no interference to the other devices.

In some embodiments, the coordinated monostatic/bistatic instance request frame indicating the beam/sector that causes no interference to the other devices includes the following scenario:

the coordinated monostatic/bistatic instance request frame includes a coordinated monostatic/bistatic instance element, wherein the coordinated monostatic/bistatic instance element includes an optional subelement, the optional subelement including at least one of a transmit beam/sector list subelement or a receive beam/sector list subelement; wherein

the transmit beam/sector list subelement indicates a transmit beam/sector that causes no interference to the other devices; and

the receive beam/sector list subelement indicates a receive beam/sector that suffers no interference from the other devices.

In some embodiments, the coordinated monostatic/bistatic instance request frame indicating the channel that causes no interference to the other devices includes the following scenario:

the coordinated monostatic/bistatic instance request frame includes a coordinated monostatic/bistatic instance element, wherein the coordinated monostatic/bistatic instance element includes a sensing channel field, the sensing channel field indicating the channel that causes no interference to the other devices.

In some embodiments, the coordinated monostatic/bistatic instance element further includes a schedule information subelement, wherein the schedule information subelement includes at least one of:

a start of PPDU field, indicating a start time for the second device to transmit a monostatic/bistatic sensing PPDU;

a length of PPDU field, indicating a length of the monostatic/bistatic sensing PPDU transmitted by the second device; or

an interval of PPDU field, indicating a period for the second device to transmit the monostatic/bistatic sensing PPDU.

In some embodiments, the interval of PPDU field indicates a time interval between two adjacent sensing PPDUs in an instance; and/or the interval of PPDU field indicates a time for a next transmission of the sensing PPDU.

In some embodiments, in the case that the first device assigns the beam/sector/channel to each of a plurality of second devices, the lengths of the monostatic/bistatic sensing PPDUs indicated by the length of PPDU fields are equal.

In some embodiments, each of the plurality of second devices is assigned equal number of the beams/sectors by the first device; and/or each of the plurality of second devices is assigned same TRN configuration information by the first device.

As shown in FIG. 17, the communication device further includes:

a third receiving module 1730, configured to receive a request message from the first device;

a second transmitting module 1740, configured to transmit at least one of location, beam information, or sector information of the second device to the first device.

In some embodiments, the third receiving module 1730 is configured to receive an information request frame or a probe request frame from the first device;

wherein the information request frame or the probe request frame carries a first identifier and/or a second identifier, wherein the first identifier is an identifier for requesting to acquire a first relevant information element of the second device, and the second identifier is an identifier for requesting to acquire a second relevant information element of the second device.

In some embodiments, the information request frame or the probe request frame carrying the first identifier and/or the second identifier includes the following scenario:

the information request frame or the probe request frame includes a request element or an extended request element, wherein the request element or the extended request element carries the first identifier and/or the second identifier.

In some embodiments, the second transmitting module 1740 is configured to transmit an information response frame or a probe response frame to the first device;

wherein the information response frame or the probe response frame includes a sensing beam element and a sensing beam description element, wherein the sensing beam element carries the first identifier and further carries the number of beams for sensing configured by the second device and/or location information of the second device, and the sensing beam description element carries the second identifier and beam information of each of the beams of the second device.

For example, the information response frame or the probe response frame includes a requested element, wherein the requested element includes the sensing beam element and the sensing beam description element.

In some embodiments, the sensing beam element includes at least one of:

an element ID field;

an element length field;

an element ID extension field, configured to carry the first identifier;

a number of beams field, configured to carry the number of beams for sensing configured by the second element;

an information control field; or

an LCI field, configured to carry the location information of the second device.

In some embodiments, the sensing beam description element includes at least one of:

an element ID field;

an element length field;

an element ID extension field, configured to carry the second identifier;

a transmit indication field, configured to indicate beam information of a transmit beam or a receive beam carried by the sensing beam description element;

a start beam index field, configured to indicate an identifier of a 1st beam carried by the sensing beam description element;

a beam index step field, configured to indicate a step between beam IDs carried by the sensing beam description element; or

a plurality of first beam descriptors, wherein each of the plurality of first beam descriptors carries beam information of one beam.

In some embodiments, the sensing beam description element includes at least one of:

an element ID field;

an element length field;

an element ID extension field, configured to carry the second identifier;

a transmit indication field, configured to indicate beam information of a transmit beam or

a receive beam carried by the sensing beam description element; or

a plurality of second beam descriptors, wherein each of the plurality of second beam descriptors carries beam information of one beam and an identifier of the beam.

In some embodiments, the third receiving module 1730 is configured to receive an information request frame or a probe request frame from the first device;

wherein the information request frame or the probe request frame carries a third identifier and/or a fourth identifier, wherein the third identifier is an identifier for requesting to acquire a third relevant information element of the second device, and the fourth identifier is an identifier for requesting to acquire a fourth relevant information element of the second device.

In some embodiments, the information request frame or the probe request frame carrying the third identifier and/or the fourth identifier includes the following scenario:

the information request frame or the probe request frame includes a request element or an extended request element, wherein the request element or the extended request element carries the third identifier and/or the fourth identifier.

In some embodiments, the second transmitting module 1740 is configured to transmit an information response frame or a probe response frame to the first device;

wherein the information response frame or the probe response frame includes a sensing sector element and a sensing sector description element, wherein the sensing sector element carries the third identifier and further carries the number of sectors for sensing configured by the second device and/or location information of the second device, and the sensing sector description element carries the fourth identifier and beam information of each of the sectors of the second device.

For example, the information response frame or the probe response frame includes a requested element, wherein the requested element includes the sensing sector element and the sensing sector description element.

In some embodiments, the sensing sector element includes at least one of:

an element ID field;

an element length field;

an element ID extension field, configured to carry the third identifier;

a number of beams field, configured to carry the number of sectors for sensing configured by the second element;

an information control field; or

an LCI field, configured to carry the location information of the second device.

In some embodiments, the sensing sector description element includes at least one of:

an element ID field;

an element length field;

an element ID extension field, configured to carry the fourth identifier;

a transmit indication field, configured to indicate sector information of a transmit sector or a receive sector carried by the sensing sector description element;

a start sector index field, configured to indicate an identifier of a 1st sector carried by the sense sector description element;

a sector index step field, configured to indicate a step between sector IDs carried by the sensing sector description element; or

a plurality of first sector descriptors, wherein each of the plurality of first sector descriptors carries sector information and a DMG antenna ID of a sector.

In some embodiments, the sensing sector description element includes at least one of: an element ID field;

an element length field;

an element ID extension field, configured to carry the fourth identifier;

a transmit indication field, configured to indicate sector information of a transmit sector or a receive sector carried by the sensing sector description element; or

a plurality of second sector descriptors, wherein each of the plurality of second sector descriptors carries sector information, a DMG antenna ID and an identifier of one sector.

It is understandable that the above and other operations and/or functions of the modules in the communication device according to some embodiments of the present disclosure are intended to realize the corresponding processes of the second device of the method 1300 shown in FIG. 13, which are not be repeated herein for brevity.

It should be noted that the functions described with respect to the modules (sub-modules, units, components, or the like) in the communication device according to the embodiments of the present disclosure are realized by different modules (sub-modules, units, components, or the like) or by the same module (sub-module, unit, component, or the like). For example, the first receiving module and the second receiving module may be different modules or may be the same module, and the first receiving module and the second receiving module in each of the cases are capable of realizing their corresponding functions according to the embodiments of the present disclosure. In addition, the transmitting module and the receiving module according to the embodiments of the present disclosure may be realized by a transceiver of the device, and some or all of the remaining modules may be realized by a processor of the device.

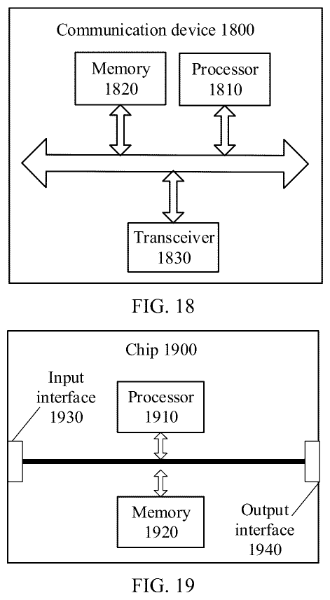

FIG. 18 is a schematic structural diagram of a communication device 1800 according to some embodiments of the present disclosure. The communication device 1800 shown in FIG. 18 includes a processor 1810, and the processor, when loading and running the one or more computer programs in a memory, causes the communication device 1800 to perform the method according to the embodiments of the present disclosure.

In some embodiments, as shown in FIG. 18, the communication device 1800 further includes a memory 1820, wherein the processor 1810, when loading and running the one or more computer programs in the memory 1820, causes the communication device 1800 to perform the method according to the embodiments of the present disclosure.

The memory 1820 may be a separate device from the processor 1810 or the memory 1820 may be integrated with the processor 1810.

In some embodiments, as shown in FIG. 18, the communication device 1800 further includes a transceiver 1830, the processor 1810 controls to the transceiver 1830 to communicate with other devices. For example, the processor 1810 controls to the transceiver 1830 to transmit information or data to the other devices, or to receive information or data from the other devices.

The transceiver 1830 may include a transmitter and a receiver. The transceiver 1830 may further include one or more antennas.

In some embodiments, the communication device 1800 is a communication device according to the embodiments of the present disclosure, and the communication device 1800 can realize corresponding processes realized by the communication device in the methods according to the embodiments of the present disclosure, which are not repeated herein for brevity.

FIG. 19 is a schematic structural diagram of a chip 1900 according to some embodiments of the present disclosure. The chip 1900 shown in FIG. 19 includes a processor 1910, wherein the processor 1910, when loading and running one or more computer programs from a memory, causes a device equipped with the chip to perform the method according to the embodiments of the present disclosure.

In some embodiments, as shown in FIG. 19, the chip 1900 further includes a memory 1920. The processor 1910, when loading and running one or more computer programs from the memory 1920, causes a device equipped with the chip 1900 to perform the method according to the embodiments of the present disclosure.

The memory 1920 is a separate device from the processor 1910 or the memory 1920 may be integrated with the processor 1910.

In some embodiments, the chip 1900 further includes an input interface 1930. The processor 1910 controls the input interface 1930 to communicate with other devices or chips. For example, the processor 1910 controls the input interface 1930 to acquire information or data transmitted by other devices or chips.

In some embodiments, the chip 1900 further includes an output interface 1940. The processor 1910 controls the output interface 1940 to communicate with other devices or chips. For example, the processor 1910 controls the output interface 1940 to output information or data to the other devices or chips.

In some embodiments, the chip is applied to the communication devices according to the embodiments of the present disclosure, and the chip can realize the corresponding processes realized by the network devices in the methods according to the embodiments of the present disclosure, which are not repeated herein for brevity.

It is understandable that the chip referred to according to the embodiments of the present disclosure can also be referred to as a system level chip, a system-on-a-chip, a chip system or a system-on chip, or the like.

The above processor may be a general-purpose processor, a digital signal processor (DSP), a field-programmable gate array (FPGA), an application specific integrated circuit (ASIC), or other programmable logic devices, transistor logic devices, discrete hardware components, or the like. The above general-purpose processor may be a microprocessor or may be any conventional processor, or the like.

The above memory may be transitory memory or non-transitory memory, or may include both the transitory memory and the non-transitory memory. The non-transitory memory may be a read-only memory (ROM), a programmable ROM (PROM), an erasable PROM (EPROM), an electrically EPROM (EEPROM), or flash memory. The transitory memory may be random access memory (RAM).

It is understandable that the above memories are exemplary but not limited thereto. For example, the memory according to the embodiments of the present disclosure may be a static RAM (SRAM), a dynamic RAM (DRAM), a synchronous DRAM (SDRAM), a double data rate SDRAM (DDR SDRAM), an enhanced SDRAM (ESDRAM),a synch link DRAM (SLDRAM), a direct rambus RAM (DR RAM), or the like. That is, the memory according to the embodiments of the present disclosure is intended to include, but is not limited to, these and any other suitable types of memories.

In the above embodiments, the embodiments may be implemented in whole or in part by software, hardware, firmware, or any combination thereof. In the case that the embodiments are implemented by the software, the embodiments may be implemented, in whole or in part, in the form of a computer program product. The computer program product includes one or more computer instructions. The one or more computer program instructions, when loaded and executed by a computer, produce, in whole or in part, a process or function according to the embodiments of the present disclosure. The computer may be a general-purpose computer, a dedicate computer, a computer network, or other programmable device. The computer instructions may be stored in a non-transitory computer-readable storage medium or transmitted from one non-transitory computer-readable storage medium to another non-transitory computer-readable storage medium, e.g., the computer instructions may be transmitted from a web site, a computer, server, or a data center over a wired connection (e.g., a coaxial cable, a fiber optics, or a digital subscriber line) or a wireless connection (e.g., infrared, wireless, microwave, etc.) to another website site, computer, server, or data center. The non-transitory computer-readable storage medium may be any usable medium that a computer can access or a data storage device such as a server, or data center that includes one or more usable medium integrated. The usable medium may be a magnetic medium, (e.g., a floppy disk, a hard disk, or a tape), an optical medium (e.g., a DVD), or a semiconductor medium (e.g., a solid state disk (SSD)), or the like.

It is understandable that in various embodiments of the present disclosure, the serial number of each of the above processes does not imply the sequence of execution, wherein the sequence of execution of the processes should be determined by their functions and inherent logics without constituting any limitation on the process of implementation of the embodiments of the present disclosure.

It is clear to those skilled in the art that, for the convenience and brevity of the description, the specific working processes of the above systems, apparatuses and elements can be referred to the corresponding processes according to the above method embodiments, which are not repeated herein.

The above description is only a specific implementation of the present disclosure, but the protection scope of the present disclosure is not limited thereto. Any changes or substitutions that can be readily thought of by any person skilled in the art within the scope of the technology disclosed in the present disclosure shall be covered by the protection scope of the present disclosure. Therefore, the protection scope of the application shall be subject to the protection scope of the claims.

What is claimed is:

1. A communication method, applicable to a first device, the method comprising:
assigning a beam/sector/channel that causes no interference to other devices to a second device, and scheduling the second device to transmit sensing information on the beam/sector/channel, wherein transmission of the sensing information causes no interference to the other devices.

2. The method according to claim 1, wherein assigning the beam/sector/channel that causes no interference to the other devices to the second device comprises:
assigning a transmit beam/sector/channel that causes no interference to the other devices to each of a plurality of second devices; and/or
assigning a receive beam/sector/channel that suffers no interference from the other devices to each of the plurality of second devices.

3. The method according to claim 1, wherein assigning the beam/sector/channel that causes no interference to the other devices to the second device comprises:
assigning a transmit beam/sector/channel that causes no interference to the first device and/or the other devices to each of one or more second devices; and/or
assigning a receive beam/sector/channel that suffers no interference from the first device and/or the other devices to each of the one or more second devices.

4. The method according to claim 1, wherein scheduling the second device to transmit the sensing information on the beam/sector/channel that causes no interference to the other devices comprises:
scheduling the second device and the other devices to transmit the sensing information simultaneously; or scheduling the second device and the other devices to transmit the sensing information sequentially; wherein the second device transmits the sensing information on the beam/sector/channel that causes no interference to the other devices.

5. The method according to claim 1, wherein assigning the beam/sector/channel that causes no interference to the other devices to the second device comprises:
transmitting a directed multi-gigabit (DMG) measurement setup request frame to the second device, wherein the DMG measurement setup request frame indicates the beam/sector/channel that causes no interference to the other devices; and/or
transmitting a coordinated monostatic/bistatic instance request frame to the second device, wherein the coordinated monostatic/bistatic instance request frame indicates the beam/sector/channel that causes no interference to the other devices.

6. The method according to claim 5, wherein in the case that the first device transmits the DMG measurement setup request frame and the coordinated monostatic/bistatic instance request frame to the second device, information indicated by the coordinated monostatic/bistatic instance request frame is configured to update information indicated by the DMG measurement setup request frame.

7. The method according to claim 6, wherein the coordinated monostatic/bistatic instance request frame indicating the beam/sector that causes no interference to the other devices comprises the following scenario:
the coordinated monostatic/bistatic instance request frame comprises a coordinated monostatic/bistatic instance element, wherein the coordinated monostatic/bistatic instance element comprises an optional subelement, the optional subelement comprising at least one of a transmit beam/sector list subelement or a receive beam/sector list subelement; wherein:
the transmit beam/sector list subelement indicates a transmit beam/sector that causes no interference to the other devices; and
the receive beam/sector list subelement indicates a receive beam/sector that suffers no interference from the other devices.

8. The method according to claim 7, wherein the coordinated monostatic/bistatic instance element further comprises a schedule information subelement, the schedule information subelement comprising at least one of:
a start of physical layer protocol data unit (PPDU) field, indicating a start time for the second device to transmit a monostatic/bistatic sensing PPDU;
a length of PPDU field, indicating a length of the monostatic/bistatic sensing PPDU transmitted by the second device, wherein in the case that the first device assigns the beam/sector/channel to each of a plurality of second devices, the lengths of the monostatic/bistatic sensing PPDUs indicated by the lengths of PPDU fields are equal; or
an interval of PPDU field, indicating a time interval between two adjacent sensing PPDUs in an instance; and/or a time for a next transmission of the sensing PPDU.

9. A communication device, comprising:
a processor; and
a memory storing one or more computer programs, which, when executed by the processor, cause the communication device to:
assign a beam/sector/channel that causes no interference to other devices to a second device, and scheduling the second device to transmit sensing information on the beam/sector/channel, wherein transmission of the sensing information causes no interference to the other devices.

10. The communication device according to claim 9, wherein the one or more computer programs, when executed by the processor, further cause the communication device to:
assign a transmit beam/sector/channel that causes no interference to the other devices to each of a plurality of second devices; and/or
assign a receive beam/sector/channel that suffers no interference from the other devices to each of the plurality of second devices.

11. The communication device according to claim 9, wherein the one or more computer programs, when executed by the processor, further cause the communication device to:
assign a transmit beam/sector/channel that causes no interference to the communication device and/or the other devices to each of one or more second devices; and/or
assign a receive beam/sector/channel that suffers no interference from the communication device and/or the other devices to each of one or more second devices.

12. The communication device according to claim 9, wherein the one or more computer programs, when executed by the processor, further cause the communication device to:
schedule the second device and the other devices to transmit the sensing information simultaneously; or scheduling the second device and the other devices to transmit the sensing information sequentially; wherein the second device transmits the sensing information on the beam/sector/channel that causes no interference to the other devices.

13. The communication device according to claim 9, wherein the one or more computer programs, when executed by the processor, further cause the communication device to:
transmit a directed multi-gigabit (DMG) measurement setup request frame to the second device, wherein the DMG measurement setup request frame indicates the beam/sector/channel that causes no interference to the other devices; and/or
transmit a coordinated monostatic/bistatic instance request frame to the second device, wherein the coordinated monostatic/bistatic instance request frame indicates the beam/sector/channel that causes no interference to the other devices.

14. The communication device according to claim 13, wherein in the case that the communication device transmits the DMG measurement setup request frame and the coordinated monostatic/bistatic instance request frame to the second device, information indicated by the coordinated monostatic/bistatic instance request frame is configured to update information indicated by the DMG measurement setup request frame.

15. A communication device, comprising:
a processor; and
a memory storing one or more computer programs, which, when executed by the processor, cause the communication device to:
transmit sensing information on a beam/sector/channel assigned by a first device, wherein the beam/sector/channel causes no interference to other devices, and transmission of the sensing information causes no interference to other devices.

16. The communication device according to claim 15, wherein the one or more computer programs, when executed by the processor, further cause the communication device to:
receive a DMG measurement setup request frame from the first device, wherein the DMG measurement setup request frame indicates the beam/sector/channel that causes no interference to the other devices; and/or
receive a coordinated monostatic/bistatic instance request frame from the first device, wherein the coordinated monostatic/bistatic instance request frame indicates the beam/sector/channel causes no interference to the other devices.

17. The communication device according to claim 16, wherein in the case that the communication device receives the DMG measurement setup request frame and the coordinated monostatic/bistatic instance request frame from the first device, the communication device updates information indicated by the DMG measurement setup request frame by using information indicated by the monostatic/bistatic instance request frame.

18. The communication device according to claim 16, wherein the DMG measurement setup request frame indicating the beam/sector/channel causes no interference to the other devices comprises the following scenario:
the DMG measurement setup request frame comprises a DMG sensing measurement setup element, wherein the DMG sensing measurement setup element comprises an optional subelement, the optional subelement comprising at least one of a transmit beam/sector list subelement or a receive beam/sector list subelement; wherein:
the transmit beam/sector list subelement indicates a transmit beam/sector that causes no interference to the other devices; and
the receive beam/sector list subelement indicates a receive beam/sector that suffers no interference from the other devices.

19. The communication device according to claim 16, wherein the coordinated monostatic/bistatic instance request frame indicating the beam/sector that causes no interference to the other devices comprises the following scenario:
the coordinated monostatic/bistatic instance request frame comprises a coordinated monostatic/bistatic instance element, wherein the coordinated monostatic/bistatic instance element comprises an optional subelement, the optional subelement comprising at least one of a transmit beam/sector list subelement or a receive beam/sector list subelement; wherein:
the transmit beam/sector list subelement indicates a transmit beam/sector that causes no interference to the other devices; and
the receive beam/sector list subelement indicates a receive beam/sector that suffers no interference from the other devices.

20. A chip, comprising: a processor, wherein the processor is configured to execute one or more computer programs stored from a memory, which causes a device equipped with the chip to perform the method of claim 1.
